(19) United States
(12) Patent Application Publication
(10) Pub. No.: US 2026/0079327 A1
(43) Pub. Date: Mar. 19, 2026

(54) OPTICAL SYSTEM AND CAMERA DEVICE COMPRISING SAME

(71) Applicant: LG INNOTEK CO., LTD., Seoul (KR)

(72) Inventor: Ju Yong SHIM, Seoul (KR)

(21) Appl. No.: 19/108,244

(22) PCT Filed: Sep. 8, 2023
(86) PCT No.: PCT/KR2023/013512

§ 371 Date: Mar. 3, 2025

(30) Foreign Application Priority Data
Sep. 8, 2022 (KR) 10-2022-0114295

(51) Int. Cl. G02B 13/00; G02B 9/62

(52) U.S. Cl. CPC G02B 13/0045; G02B 9/62

(57) ABSTRACT

An optical system according to an embodiment of the present invention comprises a first lens, a second lens, a third lens, a fourth lens, a fifth lens, and a sixth lens, which are sequentially arranged from an object side to an image side, wherein the first lens has positive refractive power, the second lens has negative refractive power, the third lens has positive refractive power, the fourth lens has negative refractive power, the fifth lens has positive refractive power, and the sixth lens has negative refractive power. The object-side surface of the sixth lens is concave toward the object side; the image-side surface of the fifth lens is convex toward the image side; the object-side surface of the fifth lens and the image-side surface of the sixth lens include a critical point at which the tilt angle is 0, and the object-side surface of the sixth lens has the largest tilt angle in the range of 0.8 to 1.2 times the vertical distance from the optical axis to the critical point of the image-side surface of the sixth lens.

### TECHNICAL FIELD

Embodiments of the present invention relate to an optical system and a camera device including the same.

### BACKGROUND ART

As the performance of a camera device built in a mobile terminal progresses, the demand for higher resolution in the camera device in the mobile terminal is also increasing. In order to improve the performance of the camera device, the high performance of an optical system and an image sensor is required. However, due to a narrow space in the mobile terminal, the high performance of the optical system and the image sensor is not easy.

Specifically, the need for miniaturization of the camera device is further increasing. As the camera device becomes smaller, an amount of light which reaches the image sensor through the optical system may decrease. Accordingly, an F-number which determines the brightness of an image can increase, and an amount of light which reaches a peripheral region of the image sensor may decrease compared to an amount of light which reaches a central region of the image sensor.

### DISCLOSURE

### Technical Problem

The technical problem to be achieved by the present invention is to acquire a camera module with a small F-number, a large field of view, and a high relative illumination while being implemented in a small size.

The problem to be solved in the embodiment is not limited to this, and it can be said that the purpose or effect that can be understood from the specific contents for implementing the solution or invention of the problem described below is also included.

### Technical Solution

An optical system according to an embodiment of the present invention includes a first lens, a second lens, a third lens, a fourth lens, a fifth lens, and a sixth lens which are sequentially disposed from an object side to an image side, wherein the first lens has positive refractive power, the second lens has negative refractive power, the third lens has positive refractive power, the fourth lens has negative refractive power, the fifth lens has positive refractive power, and the sixth lens has negative refractive power, an object-side surface of the sixth lens is concave toward the object side and an image-side surface of the fifth lens is convex toward the image side, an object-side surface of the fifth lens and an image-side surface of the sixth lens include critical points at which the tilt angle is 0, and the object-side surface of the sixth lens has a maximum tilt angle in a range of 0.8 to 1.2 times a vertical distance from an optical axis to the critical point of the image-side surface of the sixth lens.

The object-side surface of the sixth lens may have a maximum tilt angle in a range of 0.8 to 1 times the vertical distance from the optical axis to the critical point of the image-side surface of the sixth lens.

The image-side surface of the fifth lens may have a maximum tilt angle in a range of 0.8 to 1.2 times a vertical distance from the optical axis to the critical point of the object-side surface of the fifth lens.

The maximum tilt angle of the image-side surface of the fifth lens may be 20 degrees to 30 degrees in the range of 0.8 to 1.2 times the vertical distance from the optical axis to the critical point of the object-side surface of the fifth lens, and the maximum tilt angle of the object-side surface of the sixth lens may be 35 degrees to 45 degrees in the range of 0.8 to 1.2 times the vertical distance from the optical axis to the critical point of the image-side surface of the sixth lens.

An absolute value of a radius of curvature of the object-side surface of the sixth lens may be 1.2 to 1.5 times an absolute value of a radius of curvature of the image-side surface of the fifth lens.

An image-side surface of the fourth lens may include the critical point, and a vertical distance from the optical axis to a critical point of an image-side surface of the fourth lens may be 0.9 to 1.1 times a vertical distance from the optical axis to the critical point of the object-side surface of the fifth lens.

The vertical distance from the optical axis to the critical point of the image-side surface of the sixth lens may be 1.2 to 1.6 times the vertical distance from the optical axis to the critical point of the image-side surface of the fourth lens or the vertical distance from the optical axis to the critical point of the object-side surface of the fifth lens.

A center thickness of the fifth lens may be greater than a thickness of the fifth lens at the critical point of the object-side surface of the fifth lens.

A center thickness of the sixth lens may be smaller than a thickness of the sixth lens at the critical point of the image-side surface of the sixth lens.

An aperture may be disposed at an edge of an object-side surface of the first lens.

Each of the image-side surface of the fifth lens and the object-side surface of the sixth lens may not include the critical point.

An F-number may be 2.1 or less, a field of view (FOV) may be 90 degrees or more, and a relative illumination (RI) is 19% or more

A camera device according to one embodiment of the present invention includes an image sensor; a filter disposed on the image sensor; and an optical system disposed on the filter, wherein the optical system includes a first lens, a second lens, a third lens, a fourth lens, a fifth lens, and a sixth lens which are sequentially disposed from an object side to an image side, the first lens has positive refractive power, the second lens has negative refractive power, the third lens has positive refractive power, the fourth lens has negative refractive power, the fifth lens has positive refractive power, and the sixth lens has negative refractive power, an object-side surface of the sixth lens is concave toward the object side and an image-side surface of the fifth lens is convex toward the image side, an object-side surface of the fifth lens and an image-side surface of the sixth lens include critical points at which the tilt angle is 0, and the object-side surface of the sixth lens has a maximum tilt angle in a range of 0.8 to 1.2 times a vertical distance from an optical axis to the critical point of the image-side surface of the sixth lens.

### Advantageous Effects

According to the embodiment of the present invention, a camera device with a small F-number, a large field of view (FOV), and a high relative illumination (RI) while being implemented in a small size can be acquired.

According to the embodiment of the present invention, a camera device with an F-number of 2.1 or less, an FOV of 90 degrees or more, and an RI in 1 field of 19% or more while being implemented in a small size can be acquired.

According to the embodiment of the present invention, a camera device providing a bright image with a high RI while minimizing a head size exposed to the outside can be acquired. That is, in order to minimize the head size exposed to the outside, a camera device providing a bright image with a high RI around a sensor while designing a diameter of a first lens, that is, a lens disposed closest to an object side, to be small can be acquired.

### DESCRIPTION OF DRAWINGS

FIG. 1 shows an optical system according to an embodiment of the present invention.

FIG. 2 shows a relationship between a first lens and an aperture in the optical system according to the embodiment of the present invention.

FIGS. 3 and 4 are views for describing a relative illumination.

FIG. 5 is design data showing distances between lens surfaces according to a distance in a Y direction from an optical axis in the optical system according to the embodiment of the present invention.

FIG. 6 is design data showing sag values of lens surfaces according to a distance in the Y direction from the optical axis in the optical system according to the embodiment of the present invention.

FIG. 7 is design data showing tilt angles of lens surfaces according to a distance in the Y direction from the optical axis in the optical system according to the embodiment of the present invention.

FIG. 8 shows a modulation transfer function (MTF) using an optical system according to one embodiment of the present invention.

FIG. 9 shows a distortion grid using the optical system according to one embodiment of the present invention.

FIG. 10 shows an optical system according to another embodiment of the present invention.

FIG. 11 is design data showing distances between lens surfaces according to a distance in a Y direction from an optical axis in the optical system according to another embodiment of the present invention.

FIG. 12 is design data showing sag values of lens surfaces according to a distance in the Y direction from the optical axis in the optical system according to another embodiment of the present invention.

FIG. 13 is design data showing tilt angles of lens surfaces according to a distance in the Y direction from the optical axis in the optical system according to another embodiment of the present invention.

FIG. 14 shows a modulation transfer function (MTF) using the optical system according to another embodiment of the present invention.

FIG. 15 shows a distortion grid using the optical system according to another embodiment of the present invention.

FIG. 16 is a view showing a portion of a mobile terminal to which a camera device according to the embodiment of the present invention is applied.

### MODES OF THE INVENTION

Hereinafter, exemplary embodiments according to the present invention will be described in detail with reference to the accompanying drawings.

However, the technical spirit of the present invention is not limited to some embodiments to be described, but may be implemented in various different forms, and one or more of the components between the embodiments may be selectively combined and substituted within the technical spirit of the present invention.

Further, terms (including technical and scientific terms) used in the embodiments of the present invention may be interpreted as meanings which may be generally understood by those skilled in the art unless explicitly specifically defined and described, and the meanings of the generally used terms such as terms defined in a dictionary may be understood in consideration of contextual meanings in the related art.

In addition, the terms used in the embodiments of the present invention are provided not to limit the present invention but to describe the embodiments.

In the present specification, a singular form may also include a plural form unless otherwise specified in the phrase, and may include one or more of all possible combinations of A, B, and C when disclosed as at least one (or one or more) of “A, B, and C”.

Further, terms such as first, second, A, B, (a), (b), and the like may be used to describe the components of the embodiment of the present invention.

These terms are only provided to distinguish one component from another component, and the essence, sequence, order, or the like of the elements are not limited by these terms.

Further, when a specific component is disclosed as being “connected,” “coupled,” or “linked” to another component, this may not only include a case of the component being directly connected, coupled, or linked to the other component but also a case of the component being connected, coupled, or linked to the other component by another component between the element and the other component.

In addition, when one component is disclosed as being formed “on or under” another component, the term “on or under” includes both a case in which the two components are in direct contact with each other and a case in which at least another component is disposed between the two components (indirectly). In addition, when the term “on or under” is expressed, a meaning of not only an upward direction but also a downward direction may be included based on one component.

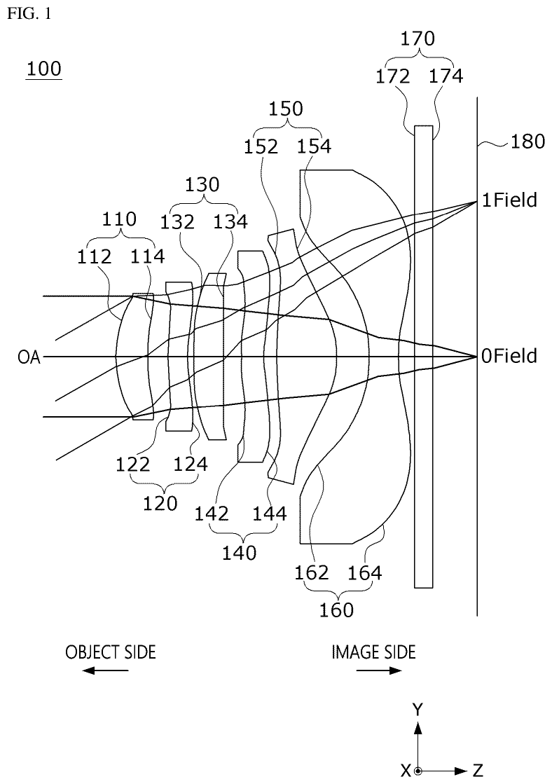

FIG. 1 shows an optical system according to an embodiment of the present invention.

Referring to FIG. 1, an optical system 100 according to the embodiment of the present invention includes a first lens 110, a second lens 120, a third lens 130, a fourth lens 140, a fifth lens 150, and a sixth lens 160, which are sequentially disposed from an object side to an image side.

Although not shown, a right-angled prism may be further disposed in front of the first lens 110.

At least one of the first lens 110, the second lens 120, the third lens 130, the fourth lens 140, the fifth lens 150, and the sixth lens 160 may include an effective region and an ineffective region. The effective region may be a region through which light incident on the lens passes, that is, a region through which the incident light is refracted to implement optical characteristics. In the present specification, an effective diameter may mean a diameter of the effective region through which effective light is incident on each surface of each lens. In the present specification, a numerical value of the effective diameter may have a certain error range. For example, a range of ±0.4 mm may be considered as the effective region for the numerical value of the effective diameter provided in the present specification. The range of ±0.4 mm may be interpreted as the effective diameter for the numerical value of the effective diameter presented in the present specification. The non-effective region is disposed at a perimeter of the effective region and may be a region where light is not incident, that is, a region unrelated to optical characteristics. The non-effective region may be a region fixed to a barrel which accommodates a lens, or the like.

According to the embodiment of the present invention, a filter 170 and an image sensor 180 may be sequentially disposed behind the sixth lens 160. In this case, the filter 170 may be an infrared (IR) filter. Accordingly, the filter 170 may block near-infrared rays, for example, light with a wavelength of 700 nm to 1100 nm, from light incident on a camera module. Alternatively, the filter 170 may be a filter which transmits IR rather than a filter which blocks IR. Further, the image sensor 180 may be connected to a printed circuit board.

Referring to FIG. 1, the optical system 100 according to the embodiment of the present invention includes the first lens 110, the second lens 120, the third lens 130, the fourth lens 140, the fifth lens 150, and the sixth lens 160, which are sequentially disposed from the object side to the image side. The first lens 110, the second lens 120, the third lens 130, the fourth lens 140, the fifth lens 150, and the sixth lens 160 may be sequentially disposed along an optical axis. The first lens 110, the second lens 120, the third lens 130, the fourth lens 140, the fifth lens 150, and the sixth lens 160 may be aspherical lenses. The first lens 110, the second lens 120, the third lens 130, the fourth lens 140, the fifth lens 150, and the sixth lens 160 may each be made of plastic or glass.

The first lens 110 has positive refractive power and includes an object-side surface 112 and an image-side surface 114, and the object-side surface 112 of the first lens 110 may be convex toward the object side and the image-side surface 114 may be concave toward the image side. Here, a case in which the surface of the lens is convex may mean that the surface of the lens in the region corresponding to the optical axis has a convex shape, and a case in which the surface of the lens is concave may mean that the surface of the lens in the region corresponding to the optical axis has a concave shape. Here, the region corresponding to the optical axis may mean an optical axis region or a paraxial region. Furthermore, the case in which the surface of the lens is convex toward the object side may mean that the surface of the lens is concave toward the image side, and the case in which the surface of the lens is convex toward the image side may mean that the surface of the lens is concave toward the object side.

The second lens 120 has negative refractive power and includes an object-side surface 122 and an image-side surface 124, and the object-side surface 122 of the second lens 120 may be convex toward the object side and the image-side surface 124 may be concave toward the image side.

The third lens 130 has positive refractive power and includes an object-side surface 132 and an image-side surface 134, and the object-side surface 132 of the third lens 130 may be convex toward the object side and the image-side surface 134 may be concave toward the image side.

The fourth lens 140 has negative refractive power and includes an object-side surface 142 and an image-side surface 144, and the object-side surface 142 of the fourth lens 140 may be convex toward the object side and the image-side surface 144 may be concave toward the image side.

The fifth lens 150 may have positive refractive power and include an object-side surface 152 and an image-side surface 154, and the object-side surface 152 of the fifth lens 150 is convex toward the object side and the image-side surface 154 is convex toward the image side.

The sixth lens 160 has negative refractive power and includes an object-side surface 162 and an image-side surface 164, and the object-side surface 162 of the sixth lens 160 may be concave toward the object side and the image-side surface 164 may be concave toward the image side.

In the embodiment of the present invention, when the first lens 110 has positive refractive power, the second lens 120 has negative refractive power, the third lens 130 has positive refractive power, the fourth lens 140 has negative refractive power, the fifth lens 150 has positive refractive power, and the sixth lens 160 has negative refractive power, chromatic aberration may be corrected.

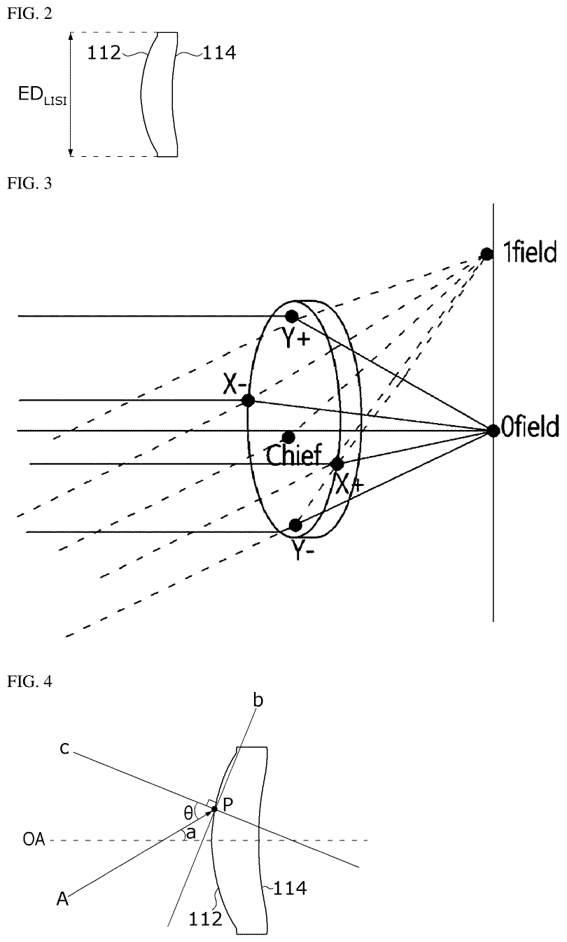

FIG. 2 shows a relationship between a first lens and an aperture in the optical system according to the embodiment of the present invention.

Referring to FIG. 2, an aperture ST is disposed on the first lens 110. The aperture ST may adjust an amount of light incident on the optical system 100. For example, the aperture ST may be disposed at an edge of the object-side surface 112 of the first lens 110. For example, the aperture ST may be disposed to contact the edge of the object-side surface 112 of the first lens 110. Accordingly, an effective diameter (ED_{L1S1}) of the first lens 110 may be 90% to 110%, preferably 95% to 110%, more preferably 97% to 110%, and more preferably 100% to 110% of an entrance pupil diameter (EPD) of the optical system 100.

Accordingly, since an area of the object-side surface 112 of the first lens 110 exposed to the outside may be minimized, a head size of the optical system 100 may be minimized. In addition, light may also be incident on the edge of the object-side surface 112 of the first lens 110. The entire first lens 110 may be an effective region.

Referring to FIG. 1 again, the object-side surface 112 of the first lens 110 has the smallest effective diameter among the first to sixth lenses. According to the embodiment of the present invention, the effective diameter of the object-side surface 112 of the first lens 110 may be smaller than a length in a diagonal direction of the image sensor 180. For example, the effective diameter of the object-side surface 112 of the first lens 110 may be 70% or less, preferably 50% or less, more preferably, 40% or less, and more preferably, 30% or less of the length in the diagonal direction of the image sensor 180. For example, the effective diameter (ED_{L1S1}) of the object-side surface 112 of the first lens 110 may be 1.422 mm to 1.738 mm, preferably 1.501 mm to 1.659 mm, and more preferably 1.55 mm to 1.61 mm. As shown in FIG. 2, since the aperture ST is disposed at the edge of the object-side surface 112 of the first lens 110, the EPD of the optical system 100 according to the embodiment of the present invention may be 1.422 mm to 1.738 mm, preferably 1.501 mm to 1.659 mm, and more preferably 1.55 mm to 1.61 mm. When the aperture ST is disposed at the edge of the object-side surface 112 of the first lens 110, since the amount of light incident on the first lens 110 may be maximized while minimizing the area of the optical system 100 exposed to the outside, the optical system 100 may be implemented in a compact size. For example, a camera device including the optical system 100 according to the embodiment of the present invention may be implemented so as not to be exposed to the user's naked eye. For example, the camera device including the optical system 100 according to the embodiment of the present invention may be implemented to be disposed on the front of a mobile terminal. For example, the camera device including the optical system 100 according to the embodiment of the present invention may be implemented to be disposed under a display.

Meanwhile, as the effective diameter of the first lens 110 becomes smaller, the head size exposed to the outside may be minimized. However, as the effective diameter of the first lens 110 becomes smaller, the amount of light incident on the optical system 100 may be insufficient. Accordingly, when the optical system including the first lens 110 is designed, it is necessary to consider conditions for brightening the image by reducing an F number and improving a ratio of an amount of light incident on the periphery of the image sensor to an amount of light incident on a central portion of the image sensor, that is, a relative Illumination (RI).

Here, the central portion of the image sensor means a region close to a 0 field of the image sensor, and the periphery of the image sensor means a region close to a 1 field of the image sensor.

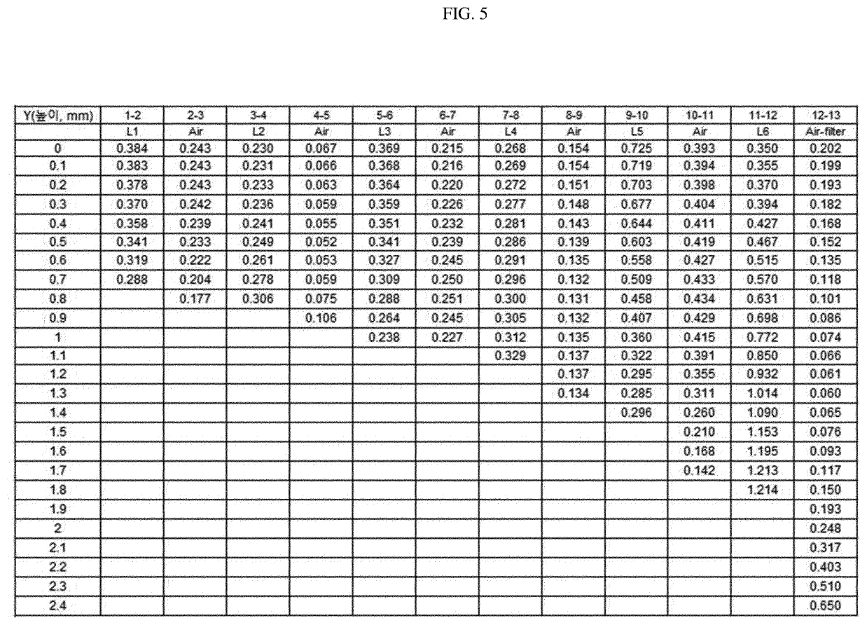

FIGS. 3 and 4 are views for describing the relative illumination.

Referring to FIG. 3, it can be seen that the area that reaches the image sensor depends on an incident angle of light incident from the object side. That is, the image sensor is divided into a 0 field region which is the central portion of the image sensor, and a 1 field region which is the farthest location from the central portion of the image sensor, and it can be seen that light reaches closer to the 1 field region (the periphery) of the image sensor as the incident angle of the light is larger, and the light reaches closer to the 0 field region (the central region) as the incident angle of the light is smaller.

Referring to FIG. 4, it is assumed that a first ray A is a ray parallel to a field of view (FOV) of the optical system 100. The first ray A may be incident on the object-side surface 112 of the first lens 110 to have an angle of a with respect to an optical axis OA of the first lens 110. In this case, an angle formed by the first ray A and a normal line (line c) at a point P where the first ray A and the object-side surface 112 of the first lens 110 contact each other may be defined as an incident angle θ.

According to the embodiment of the present invention, the lenses forming the optical system 100 are designed to reduce the F-number and improve the RI.

Tables 1 and 2 below show the optical characteristics of the lenses included in the optical system according to the embodiment of the present invention, and Tables 3 and 4 show aspheric coefficients of lenses included in the optical system according to the embodiment of the present invention.

TABLE 1

| | Lens | | | | Curvature | | Effective |
|---|---|---|---|---|---|---|---|
| Lens | Surface | | Critical | Radius of | (C, | Thickness | Diameter |
| Number | Number | Shape | Point | Curvature (R, mm) | mm) | (mm) | (mm) |
| First | 112 | Convex | Not | 1.653 | 0.6049 | 0.384 | 1.580 |
| Lens | | | Present | | | | |
| | 114 | Concave | Not | 3.383 | 0.2956 | 0.243 | 1.650 |
| | | | Present | | | | |
| Second | 122 | Convex | Present | 3.400 | 0.2941 | 0.230 | 1.715 |
| Lens | 124 | Concave | Present | 2.426 | 0.4123 | 0.067 | 1.948 |
| Third | 132 | Convex | Not | 4.702 | 0.2127 | 0.369 | 2.156 |
| Lens | | | Present | | | | |
| | 134 | Concave | Present | 126.113 | 0.0079 | 0.215 | 2.197 |
| Fourth | 142 | Convex | Present | 3.332 | 0.3001 | 0.268 | 2.340 |
| Lens | 144 | Concave | Present | 1.878 | 0.5324 | 0.154 | 2.778 |
| Fifth | 152 | Convex | Present | 2.776 | 0.3602 | 0.725 | 2.950 |
| Lens | 154 | Convex | Not | −1.264 | −0.7910 | 0.393 | 3.411 |
| | | | Present | | | | |
| Sixth | 162 | Concave | Not | −1.850 | | 0.350 | 3.693 |
| Lens | | | Present | | | | |
| | 164 | Concave | Present | 2.183 | | 0.202 | 4.914 |
| Filter | 172 | | | | | 0.210 | |
| | 174 | | | | | 0.540 | |
| Sensor | 180 | | | | | | |

TABLE 2

| | Lens | Focal | | | Ref- | Edge |
|---|---|---|---|---|---|---|
| Lens | Surface | Length | | Abbe | ractive | Thickness |
| Number | Number | (f, mm) | Power | Number | Index | (mm) |
| First Lens | 112 | 5.5857 | 0.18 | 55.7074 | 1.5371 | 0.2484 |
| | 114 | | | | | |
| Second | 122 | −13.5805 | −0.07 | 18.1193 | 1.6898 | 0.3164 |
| Lens | 124 | | | | | |
| Third | 132 | 9.0842 | 0.11 | 55.7074 | 1.5371 | 0.2300 |
| Lens | 134 | | | | | |
| | 142 | −7.4637 | −0.13 | 25.9602 | 1.6206 | 0.3030 |
| Fourth | 144 | | | | | |
| Lens | | | | | | |
| Fifth Lens | 152 | 1.7254 | 0.58 | 55.7074 | 1.5371 | 0.2780 |
| | 154 | | | | | |
| Sixth Lens | 162 | −1.8097 | −0.55 | 55.7074 | 1.5371 | 0.6256 |
| | 164 | | | | | |
| Filter | 172 | | | | | |
| | 174 | | | | | |
| Sensor | 180 | | | | | |

TABLE 3

| | First Lens | | Second Lens | | Third Lens | |
|---|---|---|---|---|---|---|
| Lens Surface | 112 | 114 | 122 | 124 | 132 | 134 |
| Number | | | | | | |
| Y radius | 1.653 | 3.383 | 3.400 | 2.426 | 4.702 | 126.113 |
| Normalization | 0.794 | 0.837 | 0.865 | 0.982 | 1.090 | 1.110 |
| radius | | | | | | |
| Conic Constant | −0.183 | −5.318 | −1.761 | −3.484 | 2.571 | 88.091 |
| 4th order | 1.25E−04 | −2.85E−02 | −1.30E−01 | −1.20E−01 | 4.59E−02 | 1.85E−02 |
| 6th order | −2.06E−04 | −6.04E−03 | −7.71E−03 | −4.50E−03 | 2.95E−03 | 1.46E−02 |
| 8th order | −3.73E−04 | −1.46E−03 | −1.54E−03 | −2.02E−04 | 1.51E−03 | 5.01E−03 |
| 10th order | −1.32E−05 | −3.71E−04 | −7.80E−05 | 3.24E−04 | 2.93E−04 | 1.02E−03 |
| 12th order | −5.65E−05 | −1.04E−04 | 4.04E−07 | 1.76E−04 | 2.13E−04 | 6.68E−04 |
| 14th order | 3.57E−06 | −7.71E−05 | 4.37E−05 | 3.72E−05 | −2.43E−06 | 2.13E−04 |
| 16th order | −1.77E−05 | −3.16E−05 | −2.73E−06 | 2.68E−05 | 3.87E−05 | 1.72E−04 |
| 18th order | 3.25E−07 | −2.43E−05 | −3.48E−07 | −1.02E−05 | −3.02E−05 | 3.17E−05 |
| 20th order | −8.90E−06 | −7.17E−06 | 2.08E−06 | 1.26E−05 | 6.08E−06 | 1.44E−05 |

TABLE 4

| | Fourth Lens | | Fifth Lens | | Sixth Lens | |
|---|---|---|---|---|---|---|
| Lens Surface | 142 | 144 | 152 | 154 | 162 | 164 |
| Number | | | | | | |
| Y radius | 3.332 | 1.878 | 2.776 | −1.264 | −1.850 | 2.183 |
| Normalization | 1.166 | 1.396 | 1.480 | 1.700 | 1.731 | 2.463 |
| radius | | | | | | |
| Conic Constant | −98.926 | −36.028 | −99.000 | −1.413 | −0.114 | −9.520 |
| 4th order | −1.04E−01 | −2.05E−01 | −1.87E−01 | 4.77E−01 | 1.83E−01 | −1.18E+00 |
| 6th order | −1.78E−02 | 2.30E−03 | −2.30E−02 | −9.45E−03 | 1.12E−01 | 3.50E−02 |
| 8th order | −6.35E−03 | −5.73E−04 | −1.60E−03 | −8.57E−03 | 2.39E−02 | −3.69E−02 |
| 10th order | −3.23E−03 | −1.43E−03 | 2.87E−03 | −6.15E−04 | −8.34E−03 | −2.11E−03 |
| 12th order | −9.76E−04 | −5.51E−04 | −2.74E−04 | −1.03E−03 | −1.34E−03 | −2.90E−03 |
| 14th order | −3.45E−04 | 4.99E−04 | 1.63E−04 | −4.87E−04 | −1.34E−04 | −2.88E−03 |
| 16th order | −1.99E−04 | 1.58E−04 | 1.70E−04 | 6.84E−05 | 3.98E−04 | −1.44E−05 |
| 18th order | 2.30E−06 | 1.53E−04 | −6.70E−06 | 1.79E−05 | 3.70E−04 | −3.43E−04 |
| 20th order | −2.70E−05 | 5.31E−06 | 6.92E−05 | −4.26E−05 | −1.50E−04 | 4.00E−04 |

In Table 1, the thickness (mm) represents a distance from each lens surface to the next lens surface. For example, the thickness disclosed for the object-side surface 112 of the first lens 110 represents a distance from the object-side surface 112 to the image-side surface 114 of the first lens 110. Here, the thickness in Table 1 may mean a center thickness. The center thickness may mean a thickness on the optical axis. Specifically, the thickness disclosed for the object-side surface 112 of the first lens 110 may represent a distance between a center of curvature of the object-side surface 112 and a center of curvature of the image-side surface 114 of the first lens 110. For convenience of description, the thickness disclosed for the object-side surface of each lens may mean a center thickness of each lens.

The thickness disclosed for the image-side surface 114 of the first lens 110 represents a distance from the image-side surface 114 of the first lens 110 to the object-side surface 122 of the second lens 120. Specifically, the thickness disclosed for the image-side surface 114 of the first lens 110 represents a distance between a center of curvature of the image-side surface 114 of the first lens 110 and a center of curvature of the object-side surface 122 of the second lens 120. For convenience of description, the thickness disclosed for the object-side surface of each lens may mean a distance on the optical axis between two lenses disposed adjacent to each other.

In the optical system 100 according to the embodiment of the present invention, the first lens 110, the second lens 120, and the third lens 130 may be referred to as a first lens group G1, and the fourth lens 140, the fifth lens 150, and the sixth lens 160 may be referred to as a second lens group G2.

According to the embodiment of the present invention, the fifth lens 150 may have the largest center thickness among the first to sixth lenses. The sum of the center thickness of the fourth lens 140 and the center thickness of the sixth lens 160 belonging to the second lens group G2 may be smaller than the center thickness of the fifth lens 150. According to the embodiment of the present invention, the center thickness of the fifth lens 150 may be 2 times or more, preferably, 2.5 times or more the center thickness of the fourth lens 140. The center thickness of the fifth lens 150 may be 1.5 times or more, preferably, 2 times or more the center thickness of the sixth lens 160. According to the embodiment of the present invention, the second lens 120 or the fourth lens 140 may have the smallest center thickness among the first to sixth lenses.

According to the embodiment of the present invention, a distance between the second lens 120 and the third lens 130 on the optical axis may have the shortest inter-lens distance among the first to sixth lenses. According to the embodiment of the present invention, a distance between the fifth lens 150 and the sixth lens 160 on the optical axis may have the longest inter-lens distance among the first to sixth lenses. According to the embodiment of the present invention, the distance between the second lens 120 and the third lens 130 on the optical axis, a distance between the fourth lens 140 and the fifth lens 150 on the optical axis, a distance between the third lens 130 and the fourth lens 140 on the optical axis, a distance between the first lens 110 and the second lens 120 on the optical axis, and the distance between the fifth lens 150 and the sixth lens 160 on the optical axis may increase in this order. The distance between the fifth lens 150 and the sixth lens 160 on the optical axis may be 1.2 to 2 times, preferably, 1.4 to 1.8 times the distance between the first lens 110 and the second lens 120 on the optical axis, may be 5 to 6.5 times, preferably, 5.5 to 6 times the distance between the second lens 120 and the third lens 130 on the optical axis, may be 1.5 to 2.5 times, preferably, 1.6 to 2 times the distance between the third lens 130 and the fourth lens 140 on the optical axis, and may be 1.5 to 3.5 times, preferably, 2 to 3 times the distance between the fourth lens 140 and the fifth lens 150 on the optical axis.

When at least one of the power of the first to sixth lens, a shape of a lens surface, the center thickness of the lens, and the distance between the lenses satisfies the above-described conditions, the first lens group G1 may serve to collect light and correct chromatic aberration, and the second lens group G2 may serve to uniformly spread light to each peripheral pixel of the image sensor. That is, according to the embodiment of the present invention, the effective diameter of the object-side surface 112 of the first lens 110 is designed to be smaller than the image sensor 180 in order to reduce the head size of the optical system 100. When the distances between the lenses in the first lens group G1 satisfies the above conditions, light may be collected without distortion even when the effective diameter of the object-side surface 112 of the first lens 110 is sufficiently small. Further, when the distances between the first lens group G and the second lens group G2 and the distances between the lenses in the second lens group G2 satisfy the above conditions, that is, when disposed farther than the distances between the lenses in the first lens group G1, the light collected by the first lens group G1 may pass through the second lens group G2 and uniformly reach each pixel of the image sensor 180 without distortion.

According to the embodiment of the present invention, the first lens 110, the second lens 120, and the third lens 130 have positive composite power, and the sixth lens 160 disposed closest to the image sensor 180 has negative power. Accordingly, the first lens 110, the second lens 120, and the third lens 130 may serve to collect light incident on the object-side surface of the first lens 110, and the sixth lens 160 may serve to spread light so that the light reaches each pixel of the image sensor 180.

In this case, the first lens 110, the second lens 120, and the third lens 130 may have positive composite power, and the fourth lens 140, the fifth lens 150, and the sixth lens 160 may also have positive composite power. That is, the composite power of the first lens 110, the second lens 120, and the third lens 130 may be 4.72, and the composite power of the fourth lens 140, the fifth lens 150, and the sixth lens 160 may be 16.11. The positive power of the fifth lens 150 may be designed to be strong so that the composite power of the fourth lens 140, the fifth lens 150, and the sixth lens 160 have positive power while the sixth lens 160 has negative power. For example, an absolute value of the power of the fifth lens 150 having positive power may be set greater than an absolute value of the power of the sixth lens 160 having negative power. In the case of the same image sensor, the stronger the positive power, that is, the shorter the effective focal length, the wider the FOV may be. As in the embodiment of the present invention, when the first lens 110, the second lens 120, and the third lens 130 have positive composite power, and the fourth lens 140, the fifth lens 150, and the sixth lens 160 have positive composite power, since the power of the first lens group G1 and the second lens group G2 are balanced, an FOV of 90 degrees or more may be acquired while having stable optical performance. Specifically, as in the embodiment of the present invention, when the first lens 110, the second lens 120, and the third lens 130 have positive composite power, the fourth lens 140, the fifth lens 150, and the sixth lens 160 have positive composite power, and the sixth lens 160 has negative power, since the power of the first lens group G1 and the power of the second lens group G2 are balanced, light may uniformly reach each pixel of the image sensor 180 while acquiring a stable FOV of 90 degrees or more. In order to allow the sixth lens 160 to uniformly disperse light to each pixel of the image sensor 180 even when the composite power of the second lens group G2 has positive power, the absolute value of the power of the sixth lens 160 having negative power may be designed to be greater than the absolute value of the power of the remaining lenses except for the fifth lens 150.

Specifically, as in the embodiment of the present invention, when the first lens 110 has positive power, the second lens 120 has negative power, an absolute value of power P1 of the first lens 110 is 2 times or more an absolute value of power P2 of the second lens 120, and a center thickness CT1 of the first lens 110 is 1.5 times or more a center thickness CT2 of the second lens, the first lens 110 may collect light incident on the optical system 100, and the second lens 120 may correct chromatic aberration.

Further, when a distance between the fifth lens 150 and the sixth lens 160 on the optical axis included in the second lens group G1 has the longest inter-lens distance among the first to sixth lenses, and the center thickness of the fifth lens 150 included in the second lens group G1 is the largest among the first to sixth lenses, the second lens group G2 may serve to more uniformly spread light to the periphery of the image sensor.

According to the embodiment of the present invention, a total track length (TTL) which is a distance from the object-side surface 112 of the first lens 110 to the image sensor 180, is 4 mm to 4.5 mm, preferably, 4.35 mm, a distance from the object-side surface 122 of the second lens 120 to the image sensor 180 is 3.7225 mm, a distance from the object-side surface 132 of the third lens 130 to the image sensor 180 is 3.4258 mm, a distance from the object-side surface 142 of the fourth lens 140 to the image sensor 180 is 2.8423 mm, a distance from the object-side surface 152 of the fifth lens 150 to the image sensor 180 is 2.4197 mm, and a distance from the object-side surface 162 of the sixth lens 160 to the image sensor 180 is 1.3016 mm. A diagonal length (2*H_{image}D) of the image sensor 180 is 6.538 mm. Further, a back focal length (BFL) which is a distance from the image-side surface 164 of the sixth lens 160 to the image sensor 180 is 0.6 mm or more. From the point of view of those skilled in the art, the BFL should be implemented at 0.6 mm or more in consideration of assembly performance. For example, in the case of a camera device having an autofocusing function, the BFL should be implemented at 0.7 mm or more for the assembly of the optical system and the image sensor, and when the optical system includes a circular asymmetrical lens, the BFL should be implemented at 0.7 mm or more. Accordingly, the optical system 100 may be implemented in a compact size and may be built into a front side as well as a rear side of a mobile terminal.

According to the embodiment of the present invention, a maximum effective diameter of the lenses included in the first lens group G1 may be smaller than a minimum effective diameter of the lenses included in the second lens group G2. Here, the effective diameter may mean a diameter of an effective region of the object-side surface or the image-side surface on which light is incident.

In this case, a maximum effective diameter (ED_{G1_max}) of the lenses included in the first lens group G1 may be 1.2 to 2 times, preferably 1.2 to 1.6 times a minimum effective diameter (ED_{G1_min}) of the lenses included in the first lens group G1. Since the minimum effective diameter (ED_{G1_min}) of the lenses included in the first lens group G1 is the effective diameter of the object-side surface 112 of the first lens 110, the effective diameters of the image-side surface 114 of the first lens 110, the object-side surface 122 and image-side surface 124 of the second lens 120, and the object-side surface 132 and image-side surface 134 of the third lens 130 may be 1.2 to 2 times the effective diameter of the object-side surface 112 of the first lens 110.

Further, the effective diameters of the fourth lens 140, the fifth lens 150, and the sixth lens 160 may gradually increase from the object side to the image side. For example, an effective diameter (ED_{L4S2}) of the image-side surface 144 of the fourth lens 140 may be larger than an effective diameter (ED_{L4S1}) of the object-side surface 142 of the fourth lens 140, an effective diameter (ED_{L5S1}) of the object-side surface 152 of the fifth lens 150 may be larger than the effective diameter (ED_{L4S2}) of the image-side surface 144 of the fourth lens 140, an effective diameter (ED_{L5S2}) of the image-side surface 154 of the fifth lens 150 may be larger than the effective diameter (ED_{L5S1}) of the object-side surface 152 of the fifth lens 150, an effective diameter (ED_{L6S1}) of the object-side surface 162 of the sixth lens 160 may be larger than the effective diameter (ED_{L5S2}) of the image-side surface 154 of the fifth lens 150, and an effective diameter (ED_{L6S2}) of the image-side surface 164 of the sixth lens 160 may be larger than the effective diameter (ED_{L6S1}) of the object-side surface 162 of the sixth lens 160.

Further, the maximum effective diameter (ED_{G1_max}) of the lenses included in the first lens group G1 may be 0.7 times or less, preferably, 0.6 times or less, and more preferably, 0.5 times or less the effective diameter (ED_{L6S2}) of the image-side surface 164 of the sixth lens 160.

Accordingly, the first lens group G1 serves to collect the light incident on the optical system 100 to adjust an incident angle of light incident on the second lens group G2. Further, the second lens group G2 may serve to disperse light incident on the second lens group G2 after passing through the first lens group G1 to increase the amount of light which reaches the periphery of the image sensor 180.

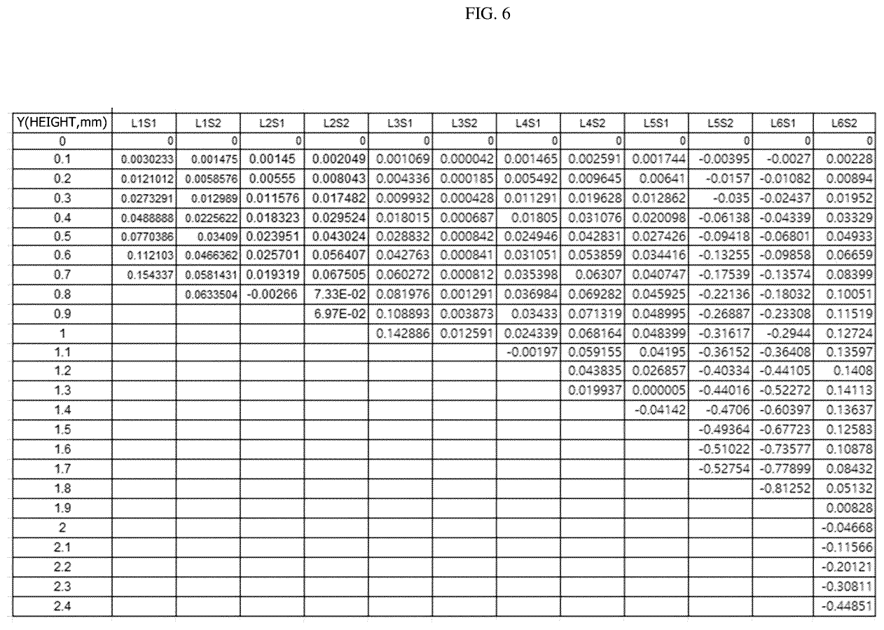

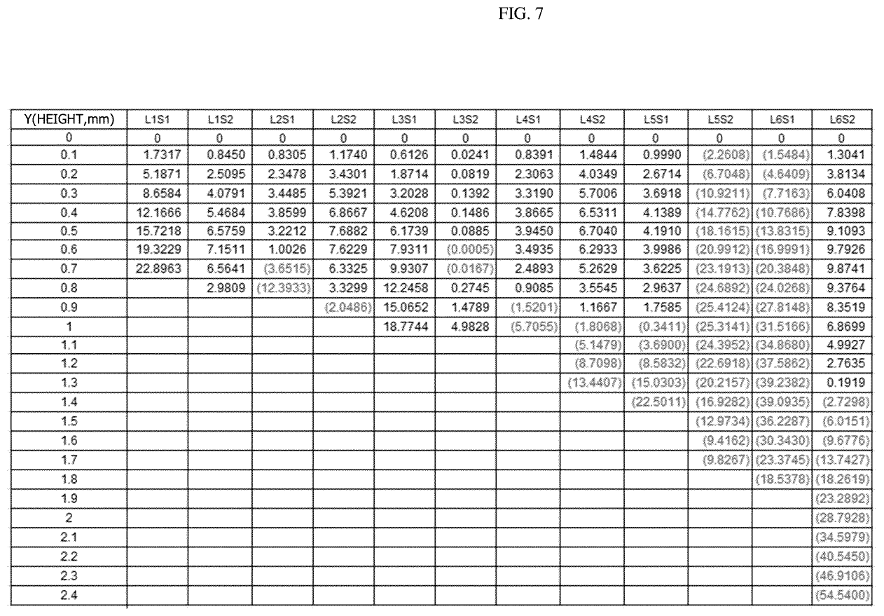

FIG. 5 is design data showing distances between lens surfaces according to a distance in a Y direction from an optical axis in the optical system according to the embodiment of the present invention, FIG. 6 is design data showing sag values of lens surfaces according to a distance in the Y direction from the optical axis in the optical system according to the embodiment of the present invention, and FIG. 7 is design data showing tilt angles of lens surfaces according to a distance in the Y direction from the optical axis in the optical system according to the embodiment of the present invention. In FIGS. 5 to 7, L1, L2, L3, L4, L5, and L6 respectively mean the first lens 110, the second lens 120, the third lens 130, the fourth lens 140, the fifth lens 150, and the sixth lens 160, and L1S1, L1S2, L2S1, L2S2, L3S1, L3S2, L4S1, L4S2, L5S1, L5S2, L6S1, and L6S2 respectively mean the object-side surface 112 and the image-side surface 114 of the first lens 110, the object-side surface 122 and the image-side surface 124 of the second lens 120, the object-side surface 132 and the image-side surface 134 of the third lens 130, the object-side surface 142 and the image-side surface 144 of the fourth lens 140, the object-side surface 152 and the image-side surface 154 of the fifth lens 150, and the object-side surface 162 and the image-side surface 164 of the sixth lens 160. Air between L1 and L2 represents the distance between the first lens 110 and the second lens 120, air between L2 and L3 represents the distance between the second lens 120 and the third lens 130, air between L3 and L4 represents the distance between the third lens 130 and the fourth lens 140, air between L4 and L5 represents the distance between the fourth lens 140 and the fifth lens 150, and air between L5 and L6 represents the distance between the fifth lens 150 and the sixth lens 160.

Referring to FIG. 5, the distance between the image-side surface 114 of the first lens 110 and the object-side surface 122 of the second lens 120 may be uniformly maintained from the optical axis to an end of the image-side surface 114 of the first lens 110. Here, the end of the surface of the lens may mean an end of an effective region of the surface of the lens. Here, the optical axis may mean a point where a distance in the Y direction is 0. Here, when a ratio of a maximum distance to a minimum distance between the facing surfaces of different lenses from the optical axis to the end of the surface of the lens is 3 times or less, it may be interpreted as that the distance between the facing surfaces of different lenses is uniformly maintained.

That is, a ratio of a maximum distance (T12ₘₐₓ) to a minimum distance (T12ₘᵢₙ) between the image-side surface 114 of the first lens 110 and the object-side surface 122 of the second lens 120 from the optical axis to the end of the image-side surface 114 of the first lens 110 may be 3 times or less, and preferably, 2 times or less.

Similarly, the distance between the image-side surface 124 of the second lens 120 and the object-side surface 132 of the third lens 130 may be uniformly maintained from the optical axis to an end of the image-side surface 124 of the first lens 120. That is, a ratio of a maximum distance (T23ₘₐₓ) to a minimum distance (T23ₘᵢₙ) between the image-side surface 124 of the second lens 120 and the object-side surface 132 of the third lens 130 from the optical axis to the end of the image-side surface 124 of the second lens 120 may be 3 times or less.

Similarly, the distance between the image-side surface 134 of the third lens 130 and the object-side surface 142 of the fourth lens 140 may be uniformly maintained from the optical axis to an end of the image-side surface 134 of the third lens 130. That is, a ratio of a maximum distance (T34ₘₐₓ) to a minimum distance (T34ₘᵢₙ) between the image-side surface 134 of the third lens 130 and the object-side surface 142 of the fourth lens 140 from the optical axis to the end of the image-side surface 134 of the third lens 130 may be 3 times or less, preferably, 2 times or less, and more preferably, 1.5 times or less.

Similarly, the distance between the image-side surface 144 of the fourth lens 140 and the object-side surface 152 of the fifth lens 150 may be uniformly maintained from the optical axis to an end of the image-side surface 144 of the fourth lens 140. That is, a ratio of a maximum distance (T45ₘₐₓ) to a minimum distance (T45ₘᵢₙ) between the image-side surface 144 of the fourth lens 140 and the object-side surface 152 of the fifth lens 150 from the optical axis to the end of the image-side surface 144 of the fourth lens 140 may be 3 times or less, preferably, 2 times or less.

Meanwhile, referring to FIGS. 6 and 7, according to the embodiment of the present invention, at least one surface of at least one of the first to sixth lenses forming the optical system 100 includes a critical point. The critical point may be defined as a point where the trend of the sag value changes. The sag value means a distance on the optical axis between any point on the lens surface and a point on the optical axis. In FIG. 6, a positive sag value means a shape protruding to the right from the optical axis, and a negative sag value means a shape protruding to the left from the optical axis. It is apparent to those skilled in the art that the sign of the sag value may be defined in reverse. For example, a case in which the sag value is negative may also mean a shape protruding to the right from the optical axis, and a case in which the sag value is positive may also mean a shape protruding to the left from the optical axis. The point where the trend of the sag value changes may be a point where the sag value increases and then decreases, or a point where the sag value decreases and then increases. The critical point may mean a point where the tilt angle becomes 0. The tilt angle may be defined as an angle formed by the normal to the tangent of the lens surface and the optical axis.

According to the embodiment of the present invention, at least one of the six surfaces of the first lens 110, the second lens 120, and the third lens 130 includes a critical point. According to the embodiment of the present invention, the object-side surface 122 of the second lens 120, the image-side surface 124 of the second lens 120, and the image-side surface 134 of the third lens 130 include critical points. Light is more effectively refracted near the critical point. That is, light passing through a lens surface including the critical point may be more effectively refracted compared to the light passing through a lens surface not including the critical point. Thus, when at least one of the six surfaces of the first lens 110, the second lens 120, and the third lens 130 includes the critical point and when the effective diameter of the object-side surface 112 of the first lens 110 is designed to be small to minimize the head size, or even when a maximum effective diameter of the first lens group G1 is designed to be smaller than a minimum effective diameter of the second lens group G2 to minimize the head size, light incident through the effective diameter of the object-side surface 112 of the first lens 110 may be refracted in the widest possible range between the first to third lenses, the light may uniformly reach the peripheral pixels of the image sensor 180, and the performance of the optical system 100 may be enhanced.

Further, according to the embodiment of the present invention, at least two of the six surfaces of the fourth lens 140, the fifth lens 150, and the sixth lens 160 include critical points. According to the embodiment of the present invention, the object-side surface 142 and image-side surface 144 of the fourth lens 140, the object-side surface 152 of the fifth lens 150, and the image-side surface 164 of the sixth lens 160 may include critical points. According to the embodiment of the present invention, the image-side surface 154 of the fifth lens 150 and the object-side surface 162 of the sixth lens 160 may not include critical points. Light is more effectively refracted near the critical point. When the critical point is present on the periphery of the image-side surface 164 of the sixth lens 160 which is a lens surface closest to the image sensor 180, it may be easy for the light effectively refracted at the periphery of the image-side surface 164 of the sixth lens 160 to uniformly reach the peripheral pixels of the image sensor 180. The periphery may be a region closer to the effective diameter region than the optical axis. Specifically, when the critical point is present on the image-side surface 164 of the sixth lens 160 which is the lens surface closest to the image sensor 180, the assembly performance of the optical system 100 may be improved compared to when the critical point is present on the image-side surface or object-side surface of the first lens 110 which is a lens surface farthest from the image sensor 180. Even when the sixth lens 160 is slightly tilted during assembly, since the assembly of the first to fifth lenses of the optical system 100 is not affected and thus optical performance is not significantly affected, the assembly performance of the optical system 100 may be improved. When the critical point is present on the image-side surface or object-side surface of the first lens 110 which is the lens surface farthest from the image sensor 180 and the first lens is tilted and assembled during the assembly, since the tilt of the assembly affects the second lens and the fifth lens which are the remaining lenses, the performance of the optical system is significantly lowered.

More specifically, according to the embodiment of the present invention, the critical point of the object-side surface 122 of the second lens 120 may be a point having a vertical distance of 0.6 mm to 0.7 mm from the optical axis. For example, when the optical axis is a starting point and the end of the object-side surface 122 of the second lens 120 is an end point, the critical point of the object-side surface 122 of the second lens 120 may be disposed at a position which is about 68% to 82%. Here, the end of the surface of the lens may mean the end of the effective region of the surface of the lens, and the position of the critical point may be a position set based on a direction perpendicular to the optical axis.

According to the embodiment of the present invention, the critical point of the image-side surface 124 of the second lens 120 may be a point having a vertical distance of 0.8 mm to 0.9 mm from the optical axis. For example, when the optical axis is a starting point and the end of the image-side surface 124 of the second lens 120 is an end point, the critical point of the image-side surface 124 of the second lens 120 may be disposed at a position which is about 80% to 94%.

According to the embodiment of the present invention, the critical point of the image-side surface 134 of the third lens 130 may be a point having a vertical distance of 0.5 mm to 0.6 mm from the optical axis. For example, when the optical axis is a starting point and the end of the image-side surface 134 of the third lens 130 is an end point, the critical point of the image-side surface 134 of the third lens 130 may be disposed at a position which is about 44% to 56%. According to the embodiment of the present invention, the image-side surface 134 of the third lens 130 may also include another critical point. For example, when the optical axis is used as a starting point and the end of the image-side surface 134 of the third lens 130 is used as an end point, the image-side surface 134 of the third lens 130 may be further disposed in a region 0.7 mm to 0.8 mm from the optical axis, that is, at a position which is about 62% to 74%.

According to the embodiment of the present invention, the critical point of the object-side surface 142 of the fourth lens 140 may be a point having a vertical distance of 0.8 mm to 0.9 mm from the optical axis. For example, when the optical axis is a starting point and the end of the object-side surface 142 of the fourth lens 140 is an end point, the critical point of the object-side surface 142 of the fourth lens 140 may be disposed at a position which is about 68% to 78%.

According to the embodiment of the present invention, the critical point of the image-side surface 144 of the fourth lens 140 may be a point having a vertical distance of 0.9 mm to 1 mm from the optical axis. For example, when the optical axis is a starting point and the end of the image-side surface 144 of the fourth lens 140 is an end point, the critical point of the image-side surface 144 of the fourth lens 140 may be disposed at a position which is about 64% to 72%.

According to the embodiment of the present invention, the critical point of the object-side surface 152 of the fifth lens 150 may be a point having a vertical distance of 0.9 mm to 1 mm from the optical axis. For example, when the optical axis is a starting point and the end of the object-side surface 152 of the fifth lens 150 is an end point, the critical point of the object-side surface 152 of the fifth lens 150 may be disposed at a position which is about 60% to 68%.

According to the embodiment of the present invention, the critical point of the image-side surface 164 of the sixth lens 160 may be a point having a vertical distance of 1.3 mm to 1.4 mm from the optical axis. For example, when the optical axis is a starting point and the end of the image-side surface 164 of the sixth lens 160 is an end point, the critical point of the image-side surface 164 of the sixth lens 160 may be disposed at a position which is about 52% to 60%.

Thus, when the critical points are present on three of the six surfaces of the first to third lenses included in the first lens group G1, light may be uniformly dispersed in the first lens group G1, output through the image-side surface 134 of the third lens 130 of the first lens group G1, and incident on the object-side surface 142 of the fourth lens 140. Specifically, when two or more critical points are present on the image-side surface 134 of the third lens 130, the light output through the image-side surface 134 of the third lens 130 of the first lens group G1 may be more uniformly incident on the object-side surface 142 of the fourth lens 140.

According to the embodiment of the present invention, the image-side surface 144 of the fourth lens 140 and the object-side surface 152 of the fifth lens 150 each include a critical point, both the image-side surface 154 of the fifth lens 150 and the object-side surface 162 of the sixth lens 160 do not include critical points, and the image-side surface 164 of the sixth lens 160 includes a critical point.

In this case, the vertical distance from the optical axis to the critical point of the image-side surface 144 of the fourth lens 140 may be 0.9 to 1.1 times, preferably 0.95 to 1.05 times, more preferably 0.97 to 1.3 times, and more preferably 0.99 to 1.01 times the vertical distance from the optical axis to the critical point of the object-side surface 152 of the fifth lens 140. Further, the vertical distance from the optical axis to the critical point of the image-side surface 164 of the sixth lens 160 may be 1.2 to 1.6 times, preferably 1.3 to 1.5 times, and more preferably 1.35 to 1.45 times the vertical distance from the optical axis to the critical point of the image-side surface 144 of the fourth lens 140 or the vertical distance from the optical axis to the critical point of the object-side surface 152 of the fifth lens 140.

Further, the image-side surface 154 of the fifth lens 150 not including a critical point is convex toward the image side, and the object-side surface 162 of the sixth lens 160 not including a critical point is concave toward the object side. Further, an absolute value of a radius of curvature (R_{L6S1}) of the object-side surface 162 of the sixth lens 160 may be 1.2 to 1.7 times, preferably, 1.3 to 1.6 times, and more preferably, 1.4 to 1.5 times an absolute value of a radius of curvature (R_{L5S2}) of the image-side surface 154 of the fifth lens 150.

When the fourth lens 140, the fifth lens 150, and the sixth lens 160 included in the second lens group G2 satisfy the above conditions, light uniformly dispersed in the first lens group G1 and output through the image-side surface 134 of the third lens 130 of the first lens group G1 and then incident on the object-side surface 142 of the fourth lens 140 may uniformly spread in the second lens group G2 and may be uniformly dispersed and then may be incident on the image sensor from the center to the periphery.

According to the embodiment of the present invention, the image-side surface 154 of the fifth lens 150 may have the largest tilt angle in a range of 0.8 to 1.2 times the vertical distance from the optical axis to the critical point of the object-side surface 152 of the fifth lens 150. That is, the vertical distance from the optical axis to a point having the largest tilt angle on the image-side surface 154 of the fifth lens 150 may be in a range of 0.8 to 1.2 times the vertical distance from the optical axis to the critical point of the object-side surface 152 of the fifth lens 140. For example, when the vertical distance from the optical axis to the critical point of the object-side surface 152 of the fifth lens 150 is 0.95 mm, the image-side surface 154 of the fifth lens 150 may have the largest tilt angle at a point having a vertical distance from the optical axis of 0.76 mm to 1.14 mm. Alternatively, according to the embodiment of the present invention, the image-side surface 154 of the fifth lens 150 may have the largest tilt angle in a range of 0.8 to 1 times the vertical distance from the optical axis to the critical point of the object-side surface 152 of the fifth lens 140. In this case, a maximum tilt angle of the image-side surface 154 of the fifth lens 150 may be 20 to 30 degrees, preferably 22 to 28 degrees, and more preferably 24 to 26 degrees.

When the relationship between the critical point of the fifth lens 150 and the tilt angle satisfies the above conditions, light may be more uniformly dispersed in the fifth lens 150.

According to the embodiment of the present invention, the object-side surface 162 of the sixth lens 160 may have the largest tilt angle in a range of 0.8 to 1.2 times a vertical distance from the optical axis to the critical point of the image-side surface 164 of the sixth lens 160. Alternatively, the object-side surface 162 of the sixth lens 160 may have a maximum tilt angle in a range of 0.8 to 1 times the vertical distance from the optical axis to the critical point of the image-side surface 164 of the sixth lens 160. In this case, the maximum tilt angle of the object-side surface 162 of the sixth lens 160 may be 35 to 45 degrees, preferably 37 to 42 degrees, and more preferably 38 to 41 degrees.

When the relationship between the critical point of the sixth lens 160 and the tilt angle satisfies the above conditions, light may be more uniformly dispersed in the sixth lens 160. In this case, the maximum tilt angle may be 65 degrees or less in a range of 60 to 90% of the effective diameter of the image-side surface 164 of the sixth lens 160. Accordingly, manufacturing performance may be improved while satisfying optical performance.

According to the embodiment of the present invention, the maximum tilt angle of the image-side surface 144 of the fourth lens 140 may be larger than a maximum tilt angle of the object-side surface 142 of the fourth lens 140, the maximum tilt angle of the object-side surface 152 of the fifth lens 150 may be larger than the maximum tilt angle of the image-side surface 144 of the fourth lens 140, the maximum tilt angle of the image-side surface 154 of the fifth lens 150 may be larger than the maximum tilt angle of the object-side surface 152 of the fifth lens 150, the maximum tilt angle of the object-side surface 162 of the sixth lens 160 may be larger than the maximum tilt angle of the image-side surface 154 of the fifth lens 150, and the maximum tilt angle of the image-side surface 164 of the sixth lens 160 may be larger than the maximum tilt angle of the object-side surface 162 of the sixth lens 160. In this case, the maximum tilt angle of the image-side surface 164 of the sixth lens 160 may be 65 degrees or less. Accordingly, the manufacturing and assembly of the lens are easy, and the light passing through the second lens group G2 may be uniformly dispersed in an effective region of each lens surface.

According to the embodiment of the present invention, a center thickness CT5 of the fifth lens 150 may be greater than a thickness of the fifth lens 150 at the end of the object-side surface 152 of the fifth lens 150, that is, a distance between the object-side surface 152 and the image-side surface 154 of the fifth lens 150 at the end of the object-side surface 152 of the fifth lens 150. According to the embodiment of the present invention, the center thickness CT5 of the fifth lens 150 may be 2.2 to 3 times, preferably, 2.2 to 2.8 times the thickness of the fifth lens 150 at the end of the object-side surface 152 of the fifth lens 150.

According to the embodiment of the present invention, the center thickness CT5 of the fifth lens 150 may be greater than the thickness of the fifth lens 150 at the critical point of the object-side surface 152 of the fifth lens 150, that is, a distance between the object-side surface 152 and the image-side surface 154 of the fifth lens 150 at the critical point of the object-side surface 152 of the fifth lens 150. According to the embodiment of the present invention, the center thickness CT5 of the fifth lens 150 may be 1.3 to 1.9 times, preferably 1.5 to 1.8 times the thickness of the fifth lens 150 at the critical point of the object-side surface 152 of the fifth lens 150.

According to the embodiment of the present invention, a center thickness CT6 of the sixth lens 160 may be less than a thickness of the sixth lens 160 at an end of the object-side surface 162 of the sixth lens 160, that is, a distance between the object-side surface 162 and the image-side surface 164 of the sixth lens 160 at the end of the object-side surface 162 of the sixth lens 160. According to the embodiment of the present invention, the center thickness CT6 of the sixth lens 160 may be 0.2 to 0.4 times, preferably, 0.25 to 0.35 times the thickness of the sixth lens 150 at the end of the object-side surface 162 of the sixth lens 160.

According to the embodiment of the present invention, the center thickness CT6 of the sixth lens 160 may be greater than the thickness of the sixth lens 160 at the critical point of the image-side surface 164 of the sixth lens 160, that is, a distance between the object-side surface 162 and the image-side surface 164 of the sixth lens 160 at the critical point of the image-side surface 164 of the sixth lens 160. According to the embodiment of the present invention, the center thickness CT6 of the sixth lens 160 may be 0.25 to 0.45 times, preferably, 0.3 to 0.4 times the thickness of the sixth lens 160 at the critical point of the image-side surface 164 of the sixth lens 160.

Accordingly, the manufacturing and assembly of the lens are easy, and the light passing through the second lens group G2 may be uniformly dispersed in an effective region of each lens surface.

The optical system 100 according to the embodiment of the present invention may satisfy at least one of the conditional equations described below. Accordingly, the optical system 100 according to the embodiment of the present invention may have an optically enhanced effect. Specifically, the optical system 100 according to the embodiment of the present invention may acquire optical performance in which an effective focal length (EFL) is 3.185 mm, the F number is 2.1 or less, the FOV in the diagonal direction is 90 degrees or more, and the RI is 19% or more in the 1 field under the condition that a half value of a diagonal length of a pixel region of the image sensor 180 (H_{imageD}) is 3.2690 mm.

$$0.9 \leq E {D}_{L 1 S 1} / EPD \leq 1.1 \qquad [ Equation 1 ]$$

Here, ED_{L1S1} is the effective diameter of the object-side surface 112 of the first lens 110, and an entrance pupil diameter (EPD) is a diameter of an entrance pupil. Accordingly, since the area of the object-side surface 112 of the first lens 110 exposed to the outside may be minimized, the head size of the optical system 100 may be minimized. In addition, light may also be incident on the edge of the object-side surface 112 of the first lens 110. The entire first lens 110 may be the effective region. Preferably, ED_{L1S1}/EPD may be 1 or more and 1.1 or less.

$$1.422 mm \leq {ED}_{L 1 S 1} \leq 1 \text{.738} mm \qquad [ Equation 2 ]$$

Accordingly, the head size of the optical system 100 may be minimized.

$$1.422 mm \leq EPD \leq 1.7 \; 38 mm \qquad [ Equation 3 ]$$

Accordingly, the head size of the optical system 100 may be minimized.

$$CT 4 + CT 6 < CT 5 \qquad [ Equation 4 ]$$

Here, CT4 is a center thickness of the fourth lens 140, CT5 is a center thickness of the fifth lens 150, and CT6 is a center thickness of the sixth lens 160. Accordingly, the assembly and alignment of the optical system are easy.

$$2 CT 4 \leq CT 5 \qquad [ Equation 5 ]$$

Accordingly, the assembly and alignment of the optical system are easy, and the light collected by the first lens group G1 may pass through the second lens group G2 and uniformly reach each pixel of the image sensor 180 without distortion.

$$1.5 CT 6 \leq CT 5 \qquad [ Equation 6 ]$$

Accordingly, the assembly and alignment of the optical system are easy, and the light collected by the first lens group G1 may pass through the second lens group G2 and uniformly reach each pixel of the image sensor 180 without distortion.

$$T 23 < T 45 < T 34 < T 12 < T 56 \qquad [ Equation 7 ]$$

Here, T23 is a distance between the second lens 120 and the third lens 130, T12 is a distance between the first lens 110 and the second lens 120, T45 is a distance between the fourth lens 140 and the fifth lens 150, T34 is a distance between the third lens 130 and the fourth lens 140, and T56 is a distance between the fifth lens 150 and the sixth lens 160. Accordingly, light may be collected without distortion through the first lens group G1 even when the effective diameter of the object-side surface 112 of the first lens 110 is sufficiently small, and the light collected by the first lens group G1 may pass through the second lens group G2 and uniformly reach each pixel of the image sensor 180 without distortion.

$$1.2 \leq T 56 / T 12 \leq 2 \qquad [ Equation 8 ]$$

Accordingly, the assembly and alignment of the optical system are easy, light may be collected without distortion through the first lens group G1 even when the effective diameter of the object-side surface 112 of the first lens 110 is sufficiently small, and the light collected by the first lens group G1 may pass through the second lens group G2 and uniformly reach each pixel of the image sensor 180 without distortion. Preferably, T56/T12 may be 1.4 or more and 1.8 or less.

$$5 \leq T 56 / T 23 \leq 6.5 \qquad [ Equation 9 ]$$

Accordingly, the assembly and alignment of the optical system are easy, light may be collected without distortion through the first lens group G1 even when the effective diameter of the object-side surface 112 of the first lens 110 is sufficiently small, and the light collected by the first lens group G1 may pass through the second lens group G2 and uniformly reach each pixel of the image sensor 180 without distortion. Preferably, T56/T23 may be 5.5 or more and 6 or less.

$$1.5 \leq T 56 / T 34 \leq 2.5 \qquad [ Equation 10 ]$$

Accordingly, the assembly and alignment of the optical system are easy, and the light collected by the first lens group G1 may pass through the second lens group G2 and uniformly reach each pixel of the image sensor 180 without distortion. Preferably, T56/T34 may be 1.6 or more and 2 or less.

$$1.5 \leq T 56 / T 45 \leq 3.5 \qquad [ Equation 11 ]$$

Accordingly, the assembly and alignment of the optical system are easy, and the light passing through the second lens group G2 may uniformly reach each pixel of the image sensor 180 without distortion. Preferably, T56/T45 may be 1.6 or more and 2 or less.

$$2 \leq \vert P 1 \vert / \vert P 2 \vert \qquad [ Equation 12 ]$$

Accordingly, the first lens 110 collects light incident on the optical system 100, and the second lens 120 may correct chromatic aberration.

$$1.5 \leq CT 1 / CT 2 \qquad [ Equation 13 ]$$

Accordingly, the first lens 110 collects light incident on the optical system 100, and the second lens 120 may correct chromatic aberration.

$$4 mm \leq TTL \leq 4.5 mm \qquad [ Equation 14 ]$$

Here, TTL is a distance from the object-side surface 112 of the first lens 110 to the image sensor 180. When the TTL is smaller than 4 mm, manufacturability is poor and it may be difficult to achieve a preferable effective focal length, and when the TTL exceeds 4.5 mm, the size of the camera device increases and thus it may be difficult to implement the camera device in a compact size in a mobile terminal.

$$0.6 mm \leq BFL \qquad [ Equation 15 ]$$

Here, BFL is a distance from the image-side surface 164 of the sixth lens 160 to the image sensor 180. Accordingly, the assembly of the optical system may be enhanced.

$$1.25 \leq TTL / EFL \leq 1.42 \qquad [ Equation 16 ]$$

Here, EFL is an effective focal length. Accordingly, a high-resolution image may be acquired even in a narrow space.

$$1.22 \leq TTL / {H}_{i m a g e D} \leq 1.38 \qquad [ Equation 17 ]$$

Accordingly, a high-resolution image may be acquired even in a narrow space.

$$2.53 \leq TTL / EPD \leq 2.85 \qquad [ Equation 18 ]$$

Accordingly, the head size of the optical system 100 and the overall size of the camera device may be miniaturized.

$$E {D}_{G 1\_ max} < E {D}_{G 2\_ min} \qquad [ Equation 19 ]$$

Here, ED_{G1_max} is the maximum effective diameter in the first lens group and ED_{G2_min} is the minimum effective diameter in the second lens group. Accordingly, the first lens group G1 may serve to collect the light incident on the optical system 100 to adjust an incident angle of light incident on the second lens group G2. Further, the second lens group G2 may serve to disperse the light incident on the second lens group G2 after passing through the first lens group G1 to increase an amount of light which reaches the periphery of the image sensor 180.

$$1 \text{.2} \leq E {D}_{G 1\_ max} / {ED}_{G 1\_ min} \leq 1.6 \qquad [ Equation 20 ]$$

Here, ED_{G1_min} is the minimum effective diameter in the first lens group. Accordingly, the first lens group G1 may serve to collect the light incident on the optical system 100 to adjust an incident angle of light incident on the second lens group G2. Further, the second lens group G2 may serve to disperse the light incident on the second lens group G2 after passing through the first lens group G1 to increase an amount of light which reaches the periphery of the image sensor 180.

$$E {D}_{L 4 S 1} < E {D}_{L 4 S 2} < E {D}_{L 5 S 1} < E {D}_{L 5 S 2} < E {D}_{L 6 S 1} < E {D}_{L 6 S 2} \qquad [ Equation 21 ]$$

Here, ED_{L4S1} is an effective diameter of the object-side surface 142 of the fourth lens 140, ED_{L4S2} is an effective diameter of the image-side surface 144 of the fourth lens 140, ED_{L5S1} is an effective diameter of the object-side surface 152 of the fifth lens 150, ED_{L5S2} is an effective diameter of the image-side surface 154 of the fifth lens 150, ED_{L6S1} is an effective diameter of the object-side surface 162 of the sixth lens 160, and ED_{L6S2} is an effective diameter of the image-side surface 164 of the sixth lens 160. Accordingly, the second lens group G2 may serve to disperse the light incident on the second lens group G2 after passing through the first lens group G1 to increase an amount of light which reaches the periphery of the image sensor 180.

$$E {D}_{G 1\_ max} / {ED}_{L 6 S 2} \leq 0.7 \qquad [ Equation 22 ]$$

Accordingly, the first lens group G1 may serve to collect the light incident on the optical system 100 to adjust an incident angle of light incident on the second lens group G2. Further, the second lens group G2 may serve to disperse the light incident on the second lens group G2 after passing through the first lens group G1 to increase an amount of light which reaches the periphery of the image sensor 180. Preferably, ED_{G1_max}/ED_{L6S2} may be 0.6 or less.

$$T 1 {2}_{max} / T {12}_{min} \leq 3 \qquad [ Equation 23 ]$$

Here, T12ₘₐₓ is a maximum distance between the image-side surface 114 of the first lens 110 and the object-side surface 122 of the second lens 120, and T12ₘᵢₙ is a minimum distance between the image-side surface 114 of the first lens 110 and the object-side surface 122 of the second lens 120. Accordingly, light may reach the object-side surface 122 of the second lens 120 from the image-side surface 114 of the first lens 110 without spreading, and the assembly of the optical system is easy.

$$T 2 {3}_{max} / T {23}_{min} \leq 3 \qquad [ Equation 24 ]$$

Here, T23ₘₐₓ is a maximum distance between the image-side surface 124 of the second lens 120 and the object-side surface 132 of the third lens 130, and T23ₘᵢₙ is a minimum distance between the image-side surface 124 of the second lens 120 and the object-side surface 132 of the third lens 130. Accordingly, light may reach the object-side surface 132 of the third lens 130 from the image-side surface 124 of the second lens 120 without spreading, and the assembly of the optical system is easy.

$$T 3 {4}_{max} / T {34}_{min} \leq 3 \qquad [ Equation 25 ]$$

Here, T34ₘₐₓ is a maximum distance between the image-side surface 134 of the third lens 130 and the object-side surface 142 of the fourth lens 140, and T34ₘᵢₙ is a minimum distance between the image-side surface 134 of the third lens 130 and the object-side surface 142 of the fourth lens 140. Accordingly, light may reach the object-side surface 142 of the fourth lens 140 from the image-side surface 134 of the third lens 130 without spreading. Preferably, T34ₘₐₓ/T34ₘᵢₙ may be 2 or less.

$$T 4 {5}_{max} / T {45}_{min} \leq 3 \qquad [ Equation 26 ]$$

Here, T45ₘₐₓ is a maximum distance between the image-side surface 144 of the fourth lens 140 and the object-side surface 152 of the fifth lens 150, and T45ₘᵢₙ is a minimum distance between the image-side surface 144 of the fourth lens 140 and the object-side surface 152 of the fifth lens 150. Accordingly, light may reach the object-side surface 152 of the fifth lens 150 from the image-side surface 144 of the fourth lens 140 without spreading. Preferably, T34ₘₐₓ/T34ₘᵢₙ may be 2 or less.

$$0 \text{.9} \leq {T\_CP}_{L 4 S 2} / {T\_CP}_{L 5 S 1} \leq 1.1 \qquad [ Equation 27 ]$$

Here, T_CP_{L4S2} is the distance from the optical axis to the critical point of the image-side surface 144 of the fourth lens 140, and T_CP_{L5S1} is a distance from the optical axis to the critical point of the object-side surface 152 of the fifth lens 150. Accordingly, the second lens group G2 may serve to efficiently refract and disperse the light incident on the second lens group G2 after passing through the first lens group G1 to increase an amount of light which reaches a periphery of the image sensor 180. Further, since the light effectively refracted at the critical point of the image-side surface 144 of the fourth lens 140 is effectively refracted again at the critical point of the object-side surface 152 of the fifth lens 150, the effective refraction effect of light may be maximized. Preferably, T_CP_{L4S2}/T_CP_{L5S1} may be 0.95 or more and 1.05 or less.

$$1 \text{.2} \leq {T\_CP}_{L 6 S 2} / {T\_CP}_{L 6 S 2} \leq 1.6 \qquad [ Equation 28 ]$$

Here, T_CP_{L6S2} is the distance from the optical axis to the critical point of the image-side surface 164 of the sixth lens 160. Accordingly, the second lens group G2 may serve to effectively refract and disperse the light incident on the second lens group G2 after passing through the first lens group G1 to increase the amount of light which reaches the periphery of the image sensor 180. Specifically, since the light effectively refracted at the critical point of the image-side surface 144 of the fourth lens 140 is effectively refracted again at the critical point of the image-side surface 164 of the sixth lens 160, the effective refraction effect of light may be maximized.

$$1 \text{.2} \leq {T\_CP}_{L 6 S 2} / {T\_CP}_{L 5 S 1} \leq 1.6 \qquad [ Equation 29 ]$$

Here, T_CP_{L6S2} is the distance from the optical axis to the critical point of the image-side surface 164 of the sixth lens 160. Since the light effectively refracted at the critical point of the object-side surface 162 of the sixth lens 160 is effectively refracted again at the critical point of the image-side surface 164 of the sixth lens 160, the effective refraction effect of light may be maximized.

$$1.2 \leq \vert {R}_{L 6 S 1} \vert / \vert {R}_{L 5 S 2} \vert \leq 1. 7 \qquad [ Equation 30 ]$$

Here, R_{L6S1} is a radius of curvature of the object-side surface 162 of the sixth lens 160, and R_{L5S2} is a radius of curvature of the image-side surface 154 of the fifth lens 150. Accordingly, the light incident on the fifth lens 150 may be efficiently dispersed through the fifth lens 150 and the sixth lens 160, and alignment of the fifth lens 150 and the sixth lens 160 is easy.

$$0.8 \leq {T \_ SA}_{L 5 S {2}_{-} max} / {T \_ CP}_{L 5 S 1} \leq 1.2 \qquad [ Equation 31 ]$$

Here, T_SA_{L5S2_max} is a vertical distance between a point having a maximum tilt angle on the image-side surface 154 of the fifth lens 150 and the optical axis, and T_CP_{L5S1} is a vertical distance between the critical point of the object-side surface 152 of the fifth lens 150 and the optical axis. Accordingly, light may be more effectively refracted in the fifth lens 150 and uniformly dispersed to reach each pixel of the image sensor 180.

$$0.8 \leq {T \_ SA}_{L 5 S {2}_{-} max} / {T \_ CP}_{L 5 S 1} \leq 1 \qquad [ Equation 32 ]$$

Here, T_SA_{L5S2_max} is a vertical distance between a point having a maximum tilt angle on the image-side surface 154 of the fifth lens 150 and the optical axis, and T_CP_{L5S1} is a vertical distance between the critical point of the object-side surface 152 of the fifth lens 150 and the optical axis. Accordingly, light may be more effectively refracted in the fifth lens 150 and uniformly dispersed to reach each pixel of the image sensor 180.

$$20 degrees < {SA}_{L 5 S {2}_{-} max} < 30 degrees \qquad [ Equation 33 ]$$

Here, SA_{LS52_max} is a maximum tilt angle of the image-side surface 154 of the fifth lens 150. This may be satisfied under the condition of Equation 31 or Equation 32. Accordingly, light may be more effectively refracted in the fifth lens 150 and uniformly dispersed to reach each pixel of the image sensor 180, and the manufacturing, assembly, and alignment of the optical system are easy.

$$0.8 \leq {T \_ SA}_{L 6 S {1}_{-} max} / {T \_ CP}_{L 6 S 2} \leq 1.2 \qquad [ Equation 34 ]$$

Here, T_SA_{L6S1_max} is a vertical distance between a point having the maximum tilt angle on the object-side surface 162 of the sixth lens 160 and the optical axis, and T_CP_{L6S2} is a vertical distance between the critical point of the image-side surface 164 of the sixth lens 160 and the optical axis. Accordingly, light may be more effectively refracted in the sixth lens 160 and uniformly dispersed to reach each pixel of the image sensor 180.

$$0.8 \leq {T \_ SA}_{L 6 S {1}_{-} max} / {T \_ CP}_{L 6 S 2} \leq 1 \qquad [ Equation 35 ]$$

Accordingly, light may be more effectively refracted in the sixth lens 160 and uniformly dispersed to reach each pixel of the image sensor 180.

$$35 degrees < {SA}_{L 6 S {1}_{-} max} < 45 degrees \qquad [ Equation 36 ]$$

Here, SA_{L6S1_max} is a maximum tilt angle of the object-side surface 162 of the sixth lens 160. This may be satisfied under the condition of Equation 34 or Equation 35. Accordingly, light may be more effectively refracted in the sixth lens 160 and uniformly dispersed to reach each pixel of the image sensor 180, and the manufacturing, assembly, and alignment of the optical system are easy.

$${SA}_{L 4 S {1}_{-} max} < {SA}_{L 4 S {2}_{-} max} < {SA}_{L 5 S {1}_{-} max} < {SA}_{L5S {2}_{-} max} < {SA}_{L 6 S {1}_{-} max} < {SA}_{L 6 S {2}_{-} max} \qquad [ Equation 37 ]$$

Here, SA_{L4S1_max} is a maximum tilt angle of the object-side surface 142 of the fourth lens 140, SAL_{4S2_max} is a maximum tilt angle of the image-side surface 144 of the fourth lens 140, SA_{L5S1_max} is a maximum tilt angle of the object-side surface 152 of the fifth lens 150, SA_{L5S2_max} is a maximum tilt angle of the image-side surface 154 of the fifth lens 150, SA_{L6S1_max} is a maximum tilt angle of the object-side surface 162 of the sixth lens 160, and SA_{L6S2_max} is a maximum tilt angle of the image-side surface 164 of the sixth lens 160. Accordingly, light may be uniformly dispersed through the second lens group G2 and may reach each pixel disposed on the periphery of the image sensor 180, and the manufacturing, assembly, and alignment of the optical system are easy.

$${SA}_{L 6 S {2}_{-} max} \leq 5 degrees \qquad [ Equation 38 ]$$

Accordingly, manufacturing performance may be improved while satisfying the performance of the optical system.

$$ET 5 < CT 5 \qquad [ Equation 39 ]$$

Here, ET5 is a thickness of the lens at the end of the fifth lens 150. Accordingly, light may be more effectively refracted at the periphery of the fifth lens 10 and uniformly dispersed to uniformly reach each pixel of the periphery of the image sensor 180.

$$2 \leq CT 5 / ET 5 \leq 3 \qquad [ Equation 40 ]$$

Accordingly, light may be more effectively refracted at a periphery of the fifth lens 150 and uniformly dispersed to uniformly reach each pixel of the periphery of the image sensor 180.

$$1.3 \leq CT 5 / CPT 5 \leq 1.9 \qquad [ Equation 41 ]$$

Here, CPT5 is a thickness of the fifth lens 150 at the critical point of the object-side surface 152 of the fifth lens 150. Accordingly, light may be more effectively refracted near the critical point of the fifth lens 150 and uniformly dispersed to uniformly reach each pixel of the periphery of the image sensor 180.

$$CT 6 < ET 6 \qquad [ Equation 42 ]$$

Here, ET6 is a thickness of the lens at the end of the sixth lens 160. Accordingly, light may be more effectively refracted at a periphery of the sixth lens 160 and uniformly dispersed to uniformly reach each pixel of the periphery of the image sensor 180.

$$0.2 \leq C T 6 / E T 6 \leq 0.4 \qquad [ Equation 43 ]$$

Accordingly, light may be more effectively refracted at a periphery of the sixth lens 160 and uniformly dispersed to uniformly reach each pixel of the periphery of the image sensor 180.

$$0.25 \leq C P T 6 / C P T 6 \leq 0.45 \qquad [ Equation 44 ]$$

Here, CPT6 is a thickness of the sixth lens 160 at the critical point of the image-side surface 164 of the sixth lens 160. Accordingly, light may be more effectively refracted near the critical point of the sixth lens 160 and uniformly dispersed to uniformly reach each pixel of the periphery of the image sensor 180.

$${ED}_{L 1 S 1} < 2 {H}_{i m a g e D} \qquad [ Equation 45 ]$$

Here, H_{imageD} is a half value of the diagonal length of the pixel region of the image sensor 170. Accordingly, a small head size may be implemented.

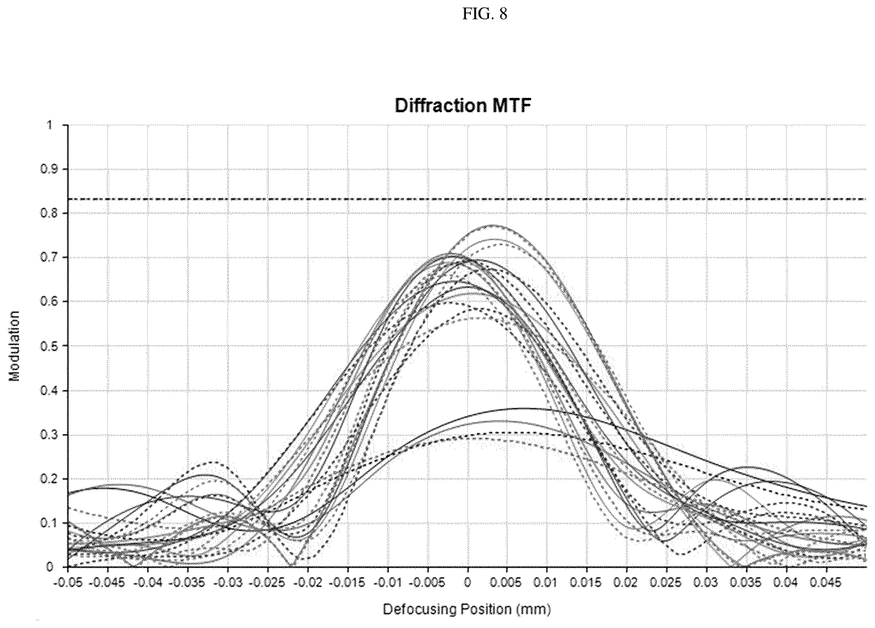

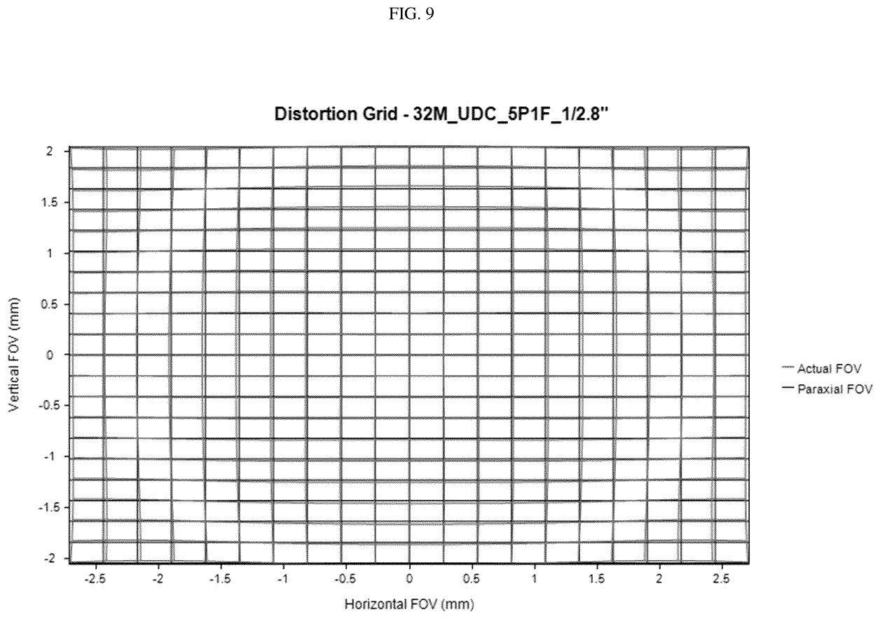

Table 5 shows chief ray angle (CRA) data and RI values which may be acquired using the optical system according to the embodiment of the present invention, by field, FIG. 8 shows a modulation transfer function (MTF) using the optical system according to the embodiment of the present invention, and FIG. 9 shows a distortion grid using the optical system according to the embodiment of the present invention.

TABLE 5

| Field | CRA | RI(%) |
|---|---|---|
| 0 | 0 | 100.0% |
| 0.1 | 7.16987 | 97.5% |
| 0.2 | 14.285 | 90.9% |
| 0.3 | 20.9738 | 82.1% |
| 0.4 | 26.7311 | 73.2% |
| 0.5 | 30.9906 | 64.6% |
| 0.6 | 33.4092 | 56.1% |
| 0.7 | 34.2921 | 47.0% |
| 0.8 | 34.2122 | 37.2% |
| 0.9 | 34.3699 | 27.4% |
| 1 | 34.3861 | 19.3% |

Referring to Table 5, in the optical system according to the embodiment of the present invention, it can be seen that an amount of light at the periphery of the image sensor (1 field) excluding the 0 field is 19% or more when a chief ray angle (CRA) is 7 degrees or more, for example, in a range of 7 degrees to 35 degrees, and an amount of light at a central portion of the image sensor (0 field) is 100%. Referring to FIG. 8, the sharpness of an image in a spatial frequency according to a pixel which may be acquired from the optical system according to one embodiment of the present invention may be acquired, and referring to FIG. 9, the degree of distortion of the image which may be acquired from the optical system according to one embodiment of the present invention may be acquired.

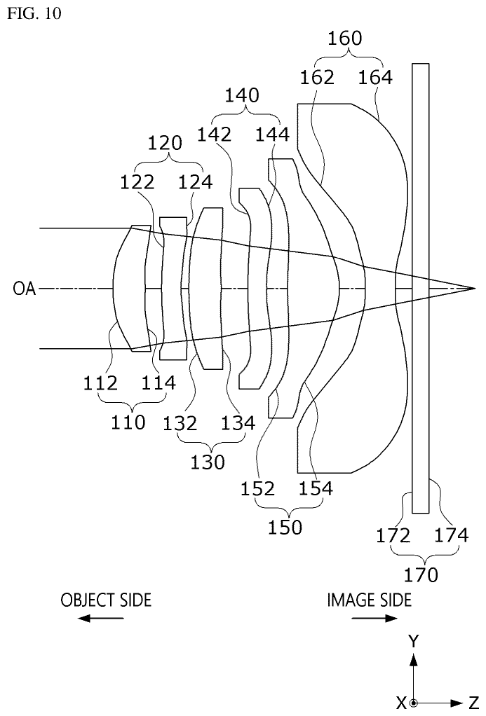

FIG. 10 shows an optical system according to another embodiment of the present invention. Overlapping descriptions of contents the same as the contents described in FIGS. 1 to 9 are omitted.

Referring to FIG. 10, an optical system 100 according to the embodiment of the present invention includes a first lens 110, a second lens 120, a third lens 130, a fourth lens 140, a fifth lens 150, and a sixth lens 160, which are sequentially disposed from an object side to an image side.

According to the embodiment of the present invention, a filter 170 and an image sensor 180 may be sequentially disposed behind the sixth lens 160.

The first lens 110, the second lens 120, the third lens 130, the fourth lens 140, the fifth lens 150, and the sixth lens 160 may be sequentially disposed along an optical axis. The first lens 110, the second lens 120, the third lens 130, the fourth lens 140, the fifth lens 150, and the sixth lens 160 may be circular symmetrical lenses. The first lens 110, the second lens 120, the third lens 130, the fourth lens 140, the fifth lens 150, and the sixth lens 160 may be aspherical lenses. The first lens 110, the second lens 120, the third lens 130, the fourth lens 140, the fifth lens 150, and the sixth lens 160 may each be made of plastic or glass.

The first lens 110 has positive refractive power and includes an object-side surface 112 and an image-side surface 114, and the object-side surface 112 of the first lens 110 may be convex toward the object side and the image-side surface 114 may be concave toward the image side.

The second lens 120 has negative refractive power and includes an object-side surface 122 and an image-side surface 124, and the object-side surface 122 of the second lens 120 may be convex toward the object side and the image-side surface 124 may be concave toward the image side.

The third lens 130 has positive refractive power and includes an object-side surface 132 and an image-side surface 134, and the object-side surface 132 of the third lens 130 may be convex toward the object side and the image-side surface 134 may be convex toward the image side.

The fourth lens 140 has negative refractive power and includes an object-side surface 142 and an image-side surface 144, and the object-side surface 142 of the fourth lens 140 may be convex toward the object side and the image-side surface 144 may be concave toward the image side.

The fifth lens 150 may have positive refractive power and include an object-side surface 152 and an image-side surface 154, and the object-side surface 152 of the fifth lens 150 is convex toward the object side and the image-side surface 154 is convex toward the image side.

The sixth lens 160 has negative refractive power and includes an object-side surface 162 and an image-side surface 164, and the object-side surface 162 of the sixth lens 160 may be concave toward the object side and the image-side surface 164 may be concave toward the image side.

In the embodiment of the present invention, when the first lens 110 has positive refractive power, the second lens 120 has negative refractive power, the third lens 130 has positive refractive power, the fourth lens 140 has negative refractive power, the fifth lens 150 has positive refractive power, and the sixth lens 160 has negative refractive power, chromatic aberration may be corrected. Although not shown, in another embodiment of the present invention, an aperture ST may also be disposed at an edge of the object-side surface 112 of the first lens 110.

According to the embodiment of the present invention, the object-side surface 112 of the first lens 110 has the smallest effective diameter among the first to sixth lenses. For example, the effective diameter (ED_{L1S1}) of the object-side surface 112 of the first lens 110 may be 1.422 mm to 1.738 mm, preferably 1.501 mm to 1.659 mm, and more preferably 1.55 mm to 1.61 mm. Since the aperture ST is disposed at the edge of the object-side surface 112 of the first lens 110, an EPD of the optical system 100 according to the embodiment of the present invention may be 1.422 mm to 1.738 mm, preferably 1.501 mm to 1.659 mm, and more preferably 1.55 mm to 1.61 mm.

Tables 6 and 7 below show the optical characteristics of the lenses included in the optical system according to another embodiment of the present invention, and Tables 8 and 9 show the Qcon coefficients of the lenses included in the optical system according to another embodiment of the present invention.

TABLE 6

| | Lens | | | | | | Effective |
|---|---|---|---|---|---|---|---|
| Lens | Surface | | Critical | Radius of | Curvature | Thickness | Diameter |
| Number | Number | Shape | Point | Curvature (R, mm) | (C, mm) | (mm) | (mm) |
| First | 112 | Convex | Not | 1.569 | 0.6373 | 0.6373 | 1.580 |
| Lens | | | Present | | | | |
| | 114 | Concave | Not | 3.358 | 0.2978 | 0.2978 | 1.617 |
| | | | Present | | | | |
| Second | 122 | Convex | Present | 4.184 | 0.2390 | 0.2390 | 1.657 |
| Lens | 124 | Concave | Present | 2.622 | 0.3814 | 0.3814 | 1.854 |
| Third | 132 | Convex | Not | 4.196 | 0.2383 | 0.2383 | 2.072 |
| Lens | | | Present | | | | |
| | 134 | Convex | Present | −35.763 | −0.0280 | −0.0280 | 2.108 |
| Fourth | 142 | Convex | Present | 2.874 | 0.3479 | 0.3479 | 2.243 |
| Lens | 144 | Concave | Present | 2.089 | 0.4786 | 0.4786 | 2.659 |
| Fifth | 152 | Convex | Present | 5.859 | 0.1707 | 0.1707 | 2.902 |
| Lens | 154 | Convex | Not | −1.236 | −0.8091 | −0.8091 | 3.507 |
| | | | Present | | | | |
| Sixth | 162 | Concave | Not | −1.859 | | 0.6373 | 3.742 |
| Lens | | | Present | | | | |
| | 164 | Concave | Present | 1.790 | | 0.2978 | 4.879 |
| Filter | 172 | | | | | 0.2390 | |
| | 174 | | | | | 0.3814 | |
| Sensor | 180 | | | | | | |

TABLE 7

| | | | | | | Edge |
|---|---|---|---|---|---|---|
| | Lens | Focal | | | | Thick- |
| Lens | Surface | Length | | Abbe | Refractive | ness |
| Number | Number | (f, mm) | Power | Number | Index | (mm) |
| First | 112 | 5.1043 | 0.20 | 55.7074 | 1.5371 | 0.2369 |
| Lens | 114 | | | | | |
| Second | 122 | −10.8326 | −0.09 | 18.1193 | 1.6898 | 0.3154 |
| Lens | 124 | | | | | |
| Third | 132 | 7.0161 | 0.14 | 55.7074 | 1.5371 | 0.2306 |
| Lens | 134 | | | | | |
| Fourth | 142 | −13.8745 | −0.07 | 25.9602 | 1.6206 | 0.2528 |
| Lens | 144 | | | | | |
| Fifth | 152 | 1.9597 | 0.51 | 55.7074 | 1.5371 | 0.2799 |
| Lens | 154 | | | | | |
| Sixth | 162 | −1.6428 | −0.61 | 55.7074 | 1.5371 | 0.5857 |
| Lens | 164 | | | | | |
| Filter | 172 | | | | | |
| | 174 | | | | | |
| Sensor | 180 | | | | | |

TABLE 8

| | First Lens | | Second Lens | | Third Lens | |
|---|---|---|---|---|---|---|
| Lens Surface | 112 | 114 | 122 | 124 | 132 | 134 |
| Number | | | | | | |
| Y radius | 1.569 | 3.358 | 4.184 | 2.622 | 4.196 | −35.763 |
| Normalization | 0.791 | 0.849 | 0.867 | 0.984 | 1.081 | 1.097 |
| radius | | | | | | |
| Conic Constant | 0.057 | −1.823 | −0.298 | −3.616 | 3.666 | −98.796 |
| 4th order | 4.22E−03 | −2.34E−02 | −1.28E−01 | −1.18E−01 | 4.91E−02 | 3.24E−02 |
| 6th order | 8.00E−04 | −3.69E−03 | −6.41E−03 | −6.10E−04 | 3.45E−03 | 1.65E−02 |
| 8th order | 3.56E−05 | −1.36E−03 | −2.11E−03 | −1.43E−04 | 1.28E−03 | 5.53E−03 |
| 10th order | 2.26E−05 | −3.05E−04 | −3.90E−04 | 6.13E−04 | 2.75E−04 | 2.67E−03 |
| 12th order | −8.99E−06 | −9.30E−05 | −2.88E−05 | 3.64E−04 | 2.01E−05 | 1.32E−03 |
| 14th order | 1.24E−06 | −1.57E−05 | 3.14E−05 | 1.48E−04 | −1.54E−04 | 5.02E−04 |
| 16th order | −2.52E−06 | −1.90E−06 | 4.04E−05 | 1.14E−04 | −1.38E−06 | 1.80E−04 |
| 18th order | 1.83E−06 | −1.11E−06 | 1.42E−05 | 2.63E−05 | −3.03E−05 | 7.68E−05 |
| 20th order | −8.37E−08 | −1.58E−06 | 5.16E−06 | 9.79E−06 | −6.95E−06 | 2.38E−05 |
| 22th order | 0.00E+00 | 0.00E+00 | 0.00E+00 | 0.00E+00 | 0.00E+00 | 0.00E+00 |
| 24th order | 0.00E+00 | 0.00E+00 | 0.00E+00 | 0.00E+00 | 0.00E+00 | 0.00E+00 |
| 26th order | 0.00E+00 | 0.00E+00 | 0.00E+00 | 0.00E+00 | 0.00E+00 | 0.00E+00 |
| 28th order | 0.00E+00 | 0.00E+00 | 0.00E+00 | 0.00E+00 | 0.00E+00 | 0.00E+00 |
| 30th order | 0.00E+00 | 0.00E+00 | 0.00E+00 | 0.00E+00 | 0.00E+00 | 0.00E+00 |

TABLE 9

| | Fourth Lens | | Fifth Lens | | Sixth Lens | |
|---|---|---|---|---|---|---|
| Lens Surface | 142 | 144 | 152 | 154 | 162 | 164 |
| Number | | | | | | |
| Y radius | 2.874 | 2.089 | 5.859 | −1.236 | −1.859 | 1.790 |
| Normalization | 1.100 | 1.314 | 1.406 | 1.697 | 1.733 | 2.474 |
| radius | | | | | | |
| Conic Constant | −68.016 | −32.057 | −90.017 | −1.501 | −0.116 | −9.816 |
| 4th order | −1.40E−01 | −2.65E−01 | −3.14E−01 | 4.45E−01 | 1.99E−01 | −1.29E+00 |
| 6th order | −2.85E−02 | −8.72E−03 | −5.33E−04 | −3.09E−02 | 1.07E−01 | 1.75E−02 |
| 8th order | −7.69E−03 | 2.75E−03 | −7.33E−03 | −1.23E−03 | 2.06E−02 | −5.53E−02 |
| 10th order | −4.11E−03 | 2.32E−03 | 4.40E−03 | −4.31E−03 | −7.72E−03 | 5.17E−03 |
| 12th order | −1.24E−03 | 1.21E−03 | −1.29E−03 | −1.01E−03 | −1.35E−03 | −1.55E−03 |
| 14th order | −5.52E−04 | 7.69E−04 | 3.38E−04 | −1.08E−04 | −2.58E−04 | 2.38E−03 |
| 16th order | −1.16E−04 | 2.19E−04 | 1.60E−04 | 6.85E−04 | 3.67E−04 | 1.24E−03 |
| 18th order | −5.96E−05 | −8.49E−05 | 1.93E−04 | 1.77E−04 | 3.66E−04 | 4.76E−04 |
| 20th order | −2.29E−05 | −7.67E−05 | −6.36E−05 | −2.97E−04 | −1.31E−04 | 7.09E−06 |
| 22th order | 0.00E+00 | 0.00E+00 | 0.00E+00 | 0.00E+00 | 0.00E+00 | 0.00E+00 |
| 24th order | 0.00E+00 | 0.00E+00 | 0.00E+00 | 0.00E+00 | 0.00E+00 | 0.00E+00 |
| 26th order | 0.00E+00 | 0.00E+00 | 0.00E+00 | 0.00E+00 | 0.00E+00 | 0.00E+00 |
| 28th order | 0.00E+00 | 0.00E+00 | 0.00E+00 | 0.00E+00 | 0.00E+00 | 0.00E+00 |
| 30th order | 0.00E+00 | 0.00E+00 | 0.00E+00 | 0.00E+00 | 0.00E+00 | 0.00E+00 |

In the optical system 100 according to the embodiment of the present invention, the first lens 110, the second lens 120, and the third lens 130 may be referred to as a first lens group G1, and the fourth lens 140, the fifth lens 150, and the sixth lens 160 may be referred to as a second lens group G2. According to the embodiment of the present invention, the fifth lens 150 may have the largest center thickness among the first to sixth lenses. The sum of the center thickness of the fourth lens 140 and the center thickness of the sixth lens 160 belonging to the second lens group G2 may be smaller than the center thickness of the fifth lens 150. According to the embodiment of the present invention, the center thickness of the fifth lens 150 may be 2 times or more the center thickness of the fourth lens 140. The center thickness of the fifth lens 150 may be 1.5 times or more the center thickness of the sixth lens 160. According to the embodiment of the present invention, the second lens 120 or the fourth lens 140 may have the smallest center thickness among the first to sixth lenses.

According to the embodiment of the present invention, a distance between the second lens 120 and the third lens 130 on the optical axis may have the shortest inter-lens distance among the first to sixth lenses. According to the embodiment of the present invention, a distance between the third lens 130 and the fourth lens 140 or between the fifth lens 150 and the sixth lens 160 on the optical axis may have the longest inter-lens distance among the first to sixth lenses. The distance between the fifth lens 150 and the sixth lens 160 on the optical axis may be 1.2 to 2 times, and preferably 1.4 to 1.8 times the distance between the first lens 110 and the second lens 120 on the optical axis, may be 2.5 to 4.5 times, and preferably 3 to 4 times the distance between the second lens 120 and the third lens 130 on the optical axis, may be 0.9 to 1.1 times, and preferably 0.95 to 1.05 times the distance between the third lens 130 and the fourth lens 140 on the optical axis, and may be 1 to 1.5 times, and preferably 1.1 to 1.3 times the distance between the fourth lens 140 and the fifth lens 150 on the optical axis.

When at least one of the power of the first to sixth lens, a shape of a lens surface, the center thickness of the lens, and the distance between the lenses satisfies the above-described conditions, the first lens group G1 may serve to correct chromatic aberration, and the second lens group G2 may serve to uniformly spread light to each peripheral pixel of the image sensor.

According to the embodiment of the present invention, TTL which is a distance from the object-side surface 112 of the first lens 110 to the image sensor 180, is 4 mm to 4.5 mm, preferably 4.32 mm, a distance from the object-side surface 122 of the second lens 120 to the image sensor 180 is 3.733 mm, a distance from the object-side surface 132 of the third lens 130 to the image sensor 180 is 3.4148 mm, a distance from the object-side surface 142 of the fourth lens 140 to the image sensor 180 is 2.714 mm, a distance from the object-side surface 152 of the fifth lens 150 to the image sensor 180 is 2.2304 mm, and a distance from the object-side surface 162 of the sixth lens 160 to the image sensor 180 is 1.3019 mm. Further, BFL which is a distance from the image-side surface 164 of the sixth lens 160 to the image sensor 180 is 0.6 mm or more.

According to the embodiment of the present invention, a maximum effective diameter of the lenses included in the first lens group G1 may be smaller than a minimum effective diameter of the lenses included in the second lens group G2. Here, the effective diameter may mean a diameter of an effective region of the object-side surface or the image-side surface on which light is incident.

In this case, a maximum effective diameter (ED_{G1_max}) of the lenses included in the first lens group G1 may be 1.2 to 1.6 times, and preferably 1.3 to 1.5 times a minimum effective diameter (ED_{G1_min}) of the lenses included in the first lens group G1.

Further, the effective diameters of the fourth lens 140, the fifth lens 150, and the sixth lens 160 may gradually increase from the object side to the image side.

Further, the maximum effective diameter (ED_{G1_max}) of the lens included in the first lens group G1 may be 0.5 times or less the effective diameter (ED_{L6S2}) of the image-side surface 164 of the sixth lens 160.

Accordingly, the first lens group G1 may serve to collect light incident on the optical system 100 to adjust an incident angle of light incident on the second lens group G2. Further, the second lens group G2 may serve to disperse light incident on the second lens group G2 after passing through the first lens group G1 to increase the amount of light which reaches the periphery of the image sensor 180.

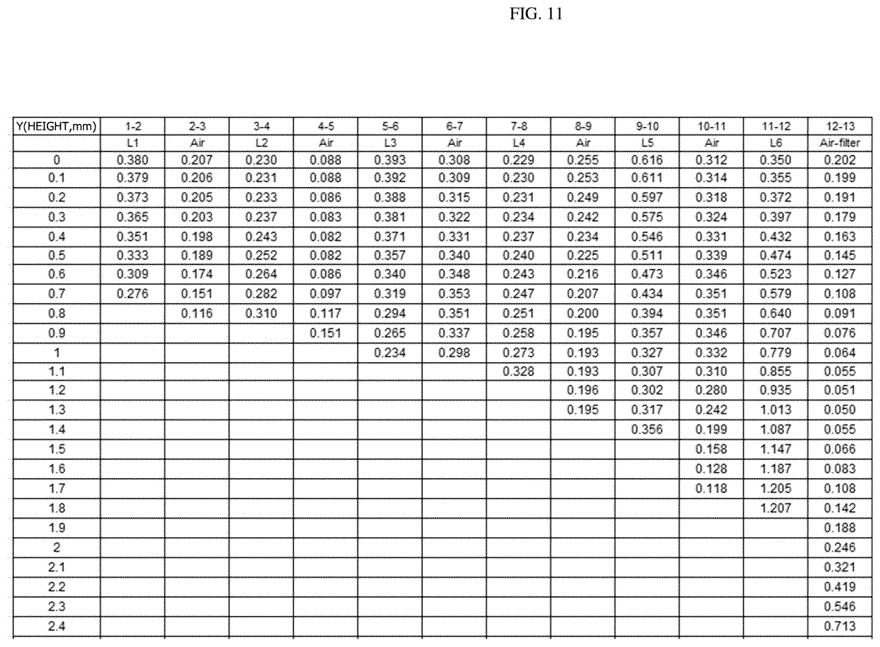

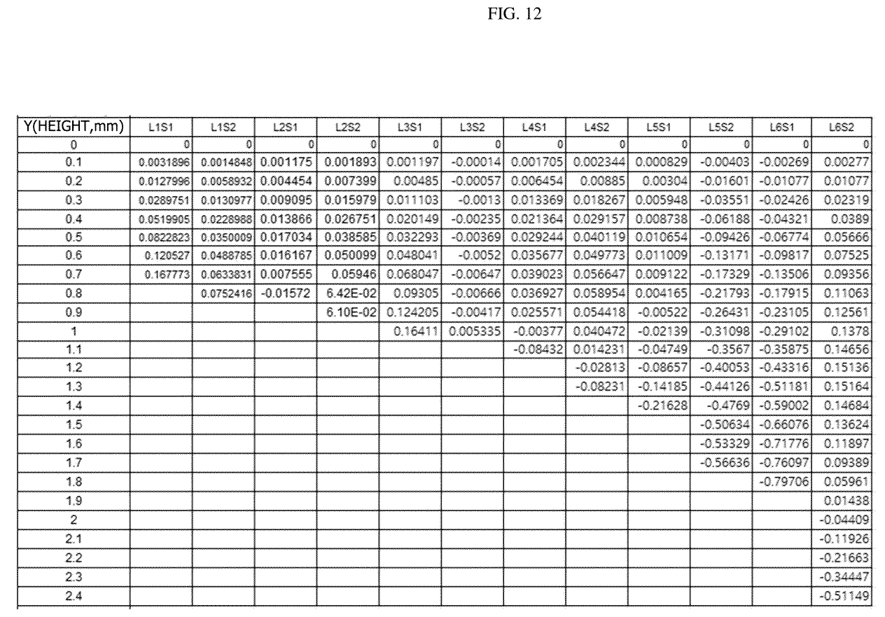

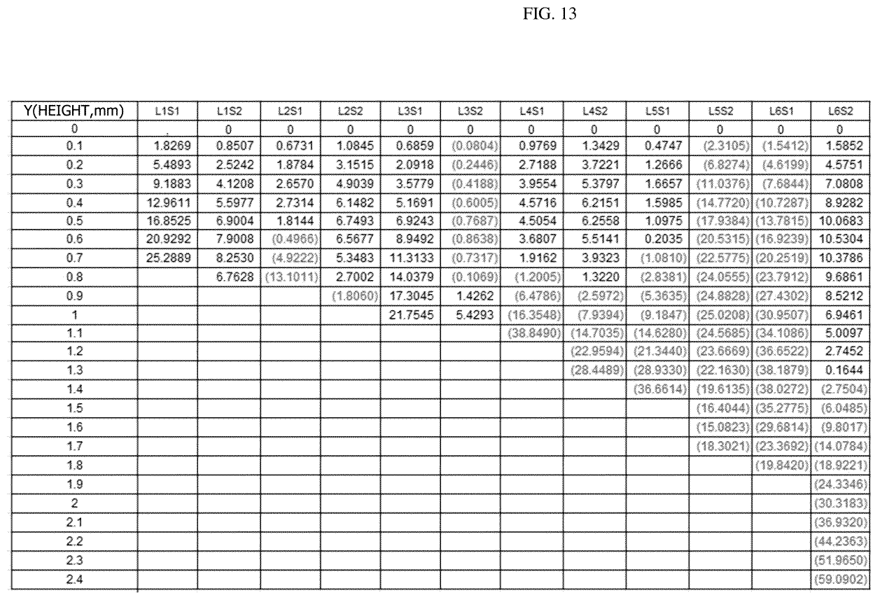

FIG. 11 is design data showing distances between lens surfaces according to a distance in a Y direction from an optical axis in the optical system according to another embodiment of the present invention, FIG. 12 is design data showing sag values of lens surfaces according to a distance in the Y direction from the optical axis in the optical system according to another embodiment of the present invention, FIG. 13 is design data showing tilt angles of lens surfaces according to a distance in the Y direction from the optical axis in the optical system according to another embodiment of the present invention.

Referring to FIGS. 11 to 13, the distance between the image-side surface 114 of the first lens 110 and the object-side surface 122 of the second lens 120 may be uniformly maintained from the optical axis to an end of the image-side surface 114 of the first lens 110. That is, a ratio of a maximum distance (T12ₘₐₓ) to a minimum distance (T12ₘᵢₙ) between the image-side surface 114 of the first lens 110 and the object-side surface 122 of the second lens 120 from the optical axis to the end of the image-side surface 114 of the first lens 110 may be 3 times or less.

Similarly, a ratio of a maximum distance (T23ₘₐₓ) to a minimum distance (T23ₘᵢₙ) between the image-side surface 124 of the second lens 120 and the object-side surface 132 of the third lens 130 from the optical axis to an end of the image-side surface 124 of the second lens 120 may be 3 times or less.

Similarly, a ratio of a maximum distance (T34ₘₐₓ) to a minimum distance (T34ₘᵢₙ) between the image-side surface 134 of the third lens 130 and the object-side surface 142 of the fourth lens 140 from the optical axis to an end of the image-side surface 134 of the third lens 130 may be 3 times or less, preferably 2 times or less, and more preferably 1.5 times or less.

Similarly, a ratio of a maximum distance (T45ₘₐₓ) to a minimum distance (T45ₘᵢₙ) between the image-side surface 144 of the fourth lens 140 and the object-side surface 152 of the fifth lens 150 from the optical axis to an end of the image-side surface 144 of the fourth lens 140 may be 3 times or less, and preferably 2 times or less.

Meanwhile, according to the embodiment of the present invention, at least one surface of at least one of the first to sixth lenses forming the optical system 100 includes a critical point. At least one of the six surfaces of the first lens 110, the second lens 120, and the third lens 130 includes a critical point. According to the embodiment of the present invention, the object-side surface 122 of the second lens 120, the image-side surface 124 of the second lens 120, and the image-side surface 134 of the third lens 130 include critical points.

Further, according to the embodiment of the present invention, at least two of the six surfaces of the fourth lens 140, the fifth lens 150, and the sixth lens 160 include critical points. According to the embodiment of the present invention, the object-side surface 142 and image-side surface 144 of the fourth lens 140, the object-side surface 152 of the fifth lens 150, and the image-side surface 164 of the sixth lens 160 may include critical points. According to the embodiment of the present invention, the image-side surface 154 of the fifth lens 150 and the object-side surface 162 of the sixth lens 160 may not include critical points.

More specifically, according to the embodiment of the present invention, the critical point of the object-side surface 122 of the second lens 120 may be a point having a vertical distance of 0.5 mm to 0.6 mm from the optical axis.

According to the embodiment of the present invention, the critical point of the image-side surface 124 of the second lens 120 may be a point having a vertical distance of 0.8 mm to 0.9 mm from the optical axis.

According to the embodiment of the present invention, the critical point of the image-side surface 134 of the third lens 130 may be a point having a vertical distance of 0.8 mm to 0.9 mm from the optical axis.

According to the embodiment of the present invention, the critical point of the object-side surface 142 of the fourth lens 140 may be a point having a vertical distance of 0.7 mm to 0.8 mm from the optical axis.

According to the embodiment of the present invention, the critical point of the image-side surface 144 of the fourth lens 140 may be a point having a vertical distance of 0.8 mm to 0.9 mm from the optical axis.

According to the embodiment of the present invention, the critical point of the object-side surface 152 of the fifth lens 150 may be a point having a vertical distance of 0.6 mm to 0.7 mm from the optical axis.

According to the embodiment of the present invention, the critical point of the image-side surface 164 of the sixth lens 160 may be a point having a vertical distance of 1.3 mm to 1.4 mm from the optical axis.

Thus, when the critical points are present on three of the six surfaces of the first to third lenses included in the first lens group G1, light may be uniformly dispersed in the first lens group G1, output through the image-side surface 134 of the third lens 130 of the first lens group G1, and incident on the object-side surface 142 of the fourth lens 140.

According to the embodiment of the present invention, the image-side surface 144 of the fourth lens 140 and the object-side surface 152 of the fifth lens 150 each include a critical point, both the image-side surface 154 of the fifth lens 150 and the object-side surface 162 of the sixth lens 160 do not include critical points, and the image-side surface 164 of the sixth lens 160 includes a critical point.

Further, the image-side surface 154 of the fifth lens 150 not including a critical point is convex toward the image side, and the object-side surface 162 of the sixth lens 160 not including critical point is concave toward the object side. Further, an absolute value of a radius of curvature (R_{L6S1}) of the object-side surface 162 of the sixth lens 160 may be 1.2 to 1.7 times, and preferably 1.3 to 1.6 times an absolute value of a radius of curvature (R_{L5S2}) of the image-side surface 154 of the fifth lens 150.

When the fourth lens 140, the fifth lens 150, and the sixth lens 160 included in the second lens group G2 satisfy the above conditions, light uniformly dispersed in the first lens group G1 and output through the image-side surface 134 of the third lens 130 of the first lens group G1 and then incident on the object-side surface 142 of the fourth lens 140 may uniformly spread in the second lens group G2 and may be uniformly dispersed and then may be incident on the image sensor from the center to the periphery.

According to the embodiment of the present invention, a maximum tilt angle of the image-side surface 154 of the fifth lens 150 may be 20 to 30 degrees, preferably 22 to 28 degrees, and more preferably 24 to 26 degrees. The maximum tilt angle of the image-side surface 154 of the fifth lens 150 may occur at a distance of 0.9 to 1.1 mm with respect to the optical axis. That is, the maximum tilt angle of the image-side surface 154 of the fifth lens 150 may occur at a distance between 51% and 63% from the optical axis to the end of the image-side surface 154 of the fifth lens 150.

According to the embodiment of the present invention, the object-side surface 162 of the sixth lens 160 may have the largest tilt angle in a range of 0.8 to 1.2 times a vertical distance from the optical axis to the critical point of the image-side surface 164 of the sixth lens 160. Alternatively, the object-side surface 162 of the sixth lens 160 may have the largest tilt angle in a range of 0.8 to 1 times the vertical distance from the optical axis to the critical point of the image-side surface 164 of the sixth lens 160. In this case, the maximum tilt angle of the object-side surface 162 of the sixth lens 160 may be 35 to 45 degrees, and preferably 37 to 42 degrees.

When the relationship between the critical point of the sixth lens 160 and the tilt angle satisfies the above conditions, light may be more uniformly dispersed in the sixth lens 160.

According to the embodiment of the present invention, the maximum tilt angle of the image-side surface 164 of the sixth lens 160 may be 65 degrees or less. Accordingly, the manufacturing and assembly of the lens are easy, and the light passing through the second lens group G2 may be uniformly dispersed in an effective region of each lens surface.

According to the embodiment of the present invention, a center thickness CT5 of the fifth lens 150 may be greater than a thickness of the fifth lens 150 at an end of the object-side surface 152 of the fifth lens 150, that is, a distance between the object-side surface 152 and the image-side surface 154 of the fifth lens 150 at the end of the object-side surface 152 of the fifth lens 150. According to the embodiment of the present invention, the center thickness CT5 of the fifth lens 150 may be 1.5 to 3 times the thickness of the fifth lens 150 at the end of the object-side surface 152 of the fifth lens 150.

According to the embodiment of the present invention, the center thickness CT5 of the fifth lens 150 may be greater than the thickness of the fifth lens 150 at the critical point of the object-side surface 152 of the fifth lens 150, that is, a distance between the object-side surface 152 and the image-side surface 154 of the fifth lens 150 at the critical point of the object-side surface 152 of the fifth lens 150. According to the embodiment of the present invention, the center thickness CT5 of the fifth lens 150 may be 1.2 to 1.4 times the thickness of the fifth lens 150 at the critical point of the object-side surface 152 of the fifth lens 150.

According to the embodiment of the present invention, a center thickness CT6 of the sixth lens 160 may be smaller than a thickness of the sixth lens 160 at an end of the object-side surface 162 of the sixth lens 160, that is, a distance between the object-side surface 162 and the image-side surface 164 of the sixth lens 160 at the end of the object-side surface 162 of the sixth lens 160. According to the embodiment of the present invention, the center thickness CT6 of the sixth lens 160 may be 0.2 to 0.4 times, and preferably 0.25 to 0.35 times the thickness of the sixth lens 150 at the end of the object-side surface 162 of the sixth lens 160.

According to the embodiment of the present invention, the center thickness CT6 of the sixth lens 160 may be greater than the thickness of the sixth lens 160 at the critical point of the image-side surface 164 of the sixth lens 160, that is, a distance between the object-side surface 162 and the image-side surface 164 of the sixth lens 160 at the critical point of the image-side surface 164 of the sixth lens 160. According to the embodiment of the present invention, the center thickness CT6 of the sixth lens 160 may be 0.25 to 0.45 times, and preferably 0.3 to 0.4 times the thickness of the sixth lens 160 at the critical point of the image-side surface 164 of the sixth lens 160.

Accordingly, the manufacturing and assembly of the lens are easy, and the light passing through the second lens group G2 may be uniformly dispersed in an effective region of each lens surface.

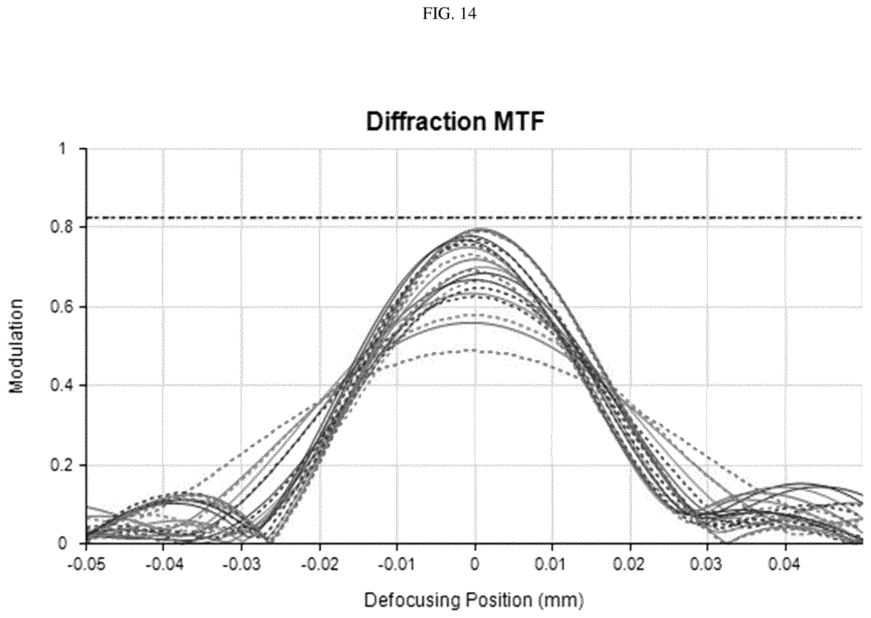

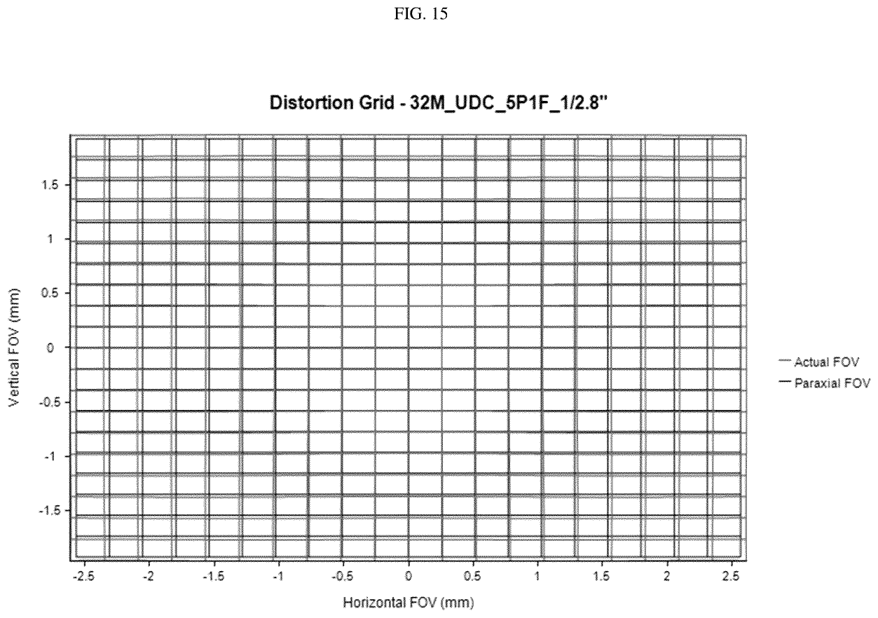

Referring to Table 10 shows chief ray angle (CRA) data and an RI value, which may be acquired using the optical system according to another embodiment of the present invention, by field, FIG. 14 shows a modulation transfer function (MTF) using the optical system according to another embodiment of the present invention, and FIG. 15 shows a distortion grid using the optical system according to another embodiment of the present invention.

TABLE 10

| Field | CRA | RI(%) |
|---|---|---|
| 0 | 0 | 100.0% |
| 0.1 | 7.58853 | 96.2% |
| 0.2 | 14.9509 | 88.8% |
| 0.3 | 21.8053 | 78.8% |
| 0.4 | 27.7551 | 68.2% |
| 0.5 | 32.3407 | 58.2% |
| 0.6 | 35.2818 | 49.1% |
| 0.7 | 36.53 | 41.2% |
| 0.8 | 36.6487 | 33.6% |
| 0.9 | 36.311 | 26.9% |
| 1 | 36.3151 | 19.5% |

Referring to Table 5, in the optical system according to the embodiment of the present invention, it can be seen that an amount of light at the periphery of the image sensor (1 field) excluding the 0 field is 19% or more when a chief ray angle (CRA) is 7 degrees or more, for example, in a range of 7 degrees to 37 degrees, and an amount of light at a central portion of the image sensor (0 field) is 100%. Referring to FIG. 14, the sharpness of an image in a spatial frequency according to a pixel which may be acquired from the optical system according to another embodiment of the present invention may be acquired, and referring to FIG. 15, a degree of distortion of the image which may be acquired from the optical system according to another embodiment of the present invention may be acquired.

The optical system 100 according to another embodiment of the present invention may acquire optical performance in which an effective focal length (EFL) is 3.478 mm, the F number is 2.3 or less, the FOV in a diagonal direction is 86 degrees or more, and the RI is 19% or more in the 1 field under the condition that a half value of a diagonal length of a pixel region of the image sensor 180 (H_{imageD}) is 3.2690 mm.

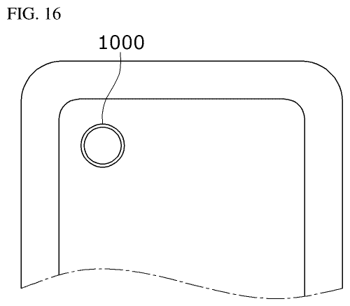

FIG. 16 is a view showing a portion of a mobile terminal to which a camera device according to the embodiment of the present invention is applied.

Meanwhile, the optical system 100 according to the embodiment of the present invention may be applied to a camera device 1000. The camera device 1000 including the optical system 100 according to the embodiment of the present invention may be built in a mobile terminal and applied along with a main camera module. The camera device 1000 according to the embodiment of the present invention may include an image sensor, a filter disposed on the image sensor, and an optical system 100 disposed on the filter, and the optical system 100 according to the embodiment of the present invention may include the above-described first lens 110, second lens 120, third lens 130, fourth lens 140, and fifth lens 150. The mobile terminal with a built-in camera device including the optical system according to the embodiment of the present invention may be a smartphone, a tablet personal computer (PC), a laptop computer, a personal digital assistant (PDA), or the like.

The optical system 100 according to the embodiment of the present invention may be disposed at the front or rear side of the mobile terminal, or may be disposed under a display of the mobile terminal.

The optical system 100 according to the embodiment of the present invention may be sequentially disposed in a lateral direction of the mobile terminal due to a thickness constraint of the mobile terminal. To this end, as described above, a right-angled prism may be further disposed on a front end of the first lens 110.

The mobile terminal may be a smartphone, a tablet PC, a laptop computer, a PDA, or the like.

Although the embodiments have been mainly described above, these are merely examples and are not intended to limit the present invention, and it can be seen that various modifications and applications not exemplified herein are possible without departing from the essential characteristics of the present invention by those skilled in the art. For example, each of the components specifically shown in the embodiments may be modified and implemented. Further, it should be interpreted that differences related to the modifications and the applications are included in the scope of the present invention defined by the appended claims.

### REFERENCE NUMERALS

100: optical system
110: first lens
120: second lens
130: third lens
140: fourth lens
150: fifth lens
160: sixth lens
170: filter
180: image sensor

1. An optical system comprising a first lens, a second lens, a third lens, a fourth lens, a fifth lens, and a sixth lens which are sequentially disposed from an object side to an image side,
wherein the first lens has positive refractive power, the second lens has negative refractive power, the third lens has positive refractive power, the fourth lens has negative refractive power, the fifth lens has positive refractive power, and the sixth lens has negative refractive power,
an object-side surface of the sixth lens is concave toward the object side and an image-side surface of the fifth lens is convex toward the image side,
an object-side surface of the fifth lens and an image-side surface of the sixth lens include critical points at which the tilt angle is 0, and
the object-side surface of the sixth lens has a maximum tilt angle in a range of 0.8 to 1.2 times a vertical distance from an optical axis to the critical point of the image-side surface of the sixth lens.

2. The optical system of claim 1, wherein the image-side surface of the fifth lens has a maximum tilt angle in a range of 0.8 to 1.2 times a vertical distance from the optical axis to the critical point of the object-side surface of the fifth lens.

3. The optical system of claim 2, wherein:
the maximum tilt angle of the image-side surface of the fifth lens is 20 degrees to 30 degrees in the range of 0.8 to 1.2 times the vertical distance from the optical axis to the critical point of the object-side surface of the fifth lens; and
the maximum tilt angle of the object-side surface of the sixth lens is 35 degrees to 45 degrees in the range of 0.8 to 1.2 times the vertical distance from the optical axis to the critical point of the image-side surface of the sixth lens.

4. The optical system of claim 1, wherein an absolute value of a radius of curvature of the object-side surface of the sixth lens is 1.2 to 1.5 times an absolute value of a radius of curvature of the image-side surface of the fifth lens.

5. The optical system of claim 1, wherein:
an image-side surface of the fourth lens includes the critical point; and
a vertical distance from the optical axis to a critical point of an image-side surface of the fourth lens is 0.9 to 1.1 times a vertical distance from the optical axis to the critical point of the object-side surface of the fifth lens.

6. The optical system of claim 5, wherein the vertical distance from the optical axis to the critical point of the image-side surface of the sixth lens is 1.2 to 1.6 times the vertical distance from the optical axis to the critical point of the image-side surface of the fourth lens or the vertical distance from the optical axis to the critical point of the object-side surface of the fifth lens.

7. The optical system of claim 1, wherein a center thickness of the fifth lens is greater than a thickness of the fifth lens at the critical point of the object-side surface of the fifth lens.

8. The optical system of claim 7, wherein a center thickness of the sixth lens is smaller than a thickness of the sixth lens at the critical point of the image-side surface of the sixth lens.

9. The optical system of claim 1, wherein an aperture is disposed at an edge of an object-side surface of the first lens.

10. The optical system of claim 1, wherein an F-number is 2.1 or less, a field of view (FOV) is 90 degrees or more, and a relative illumination (RI) is 19% or more.

11. The optical system of claim 1, wherein the object-side surface of the sixth lens has a maximum tilt angle in a range of 0.8 to 1 times the vertical distance from the optical axis to the critical point of the image-side surface of the sixth lens.

12. The optical system of claim 1, wherein each of the image-side surface of the fifth lens and the object-side surface of the sixth lens do not include the critical point.

13. The optical system of claim 1, wherein an object-side surface of the first lens has the smallest effective diameter among the first to sixth lenses.

14. The optical system of claim 1, wherein a distance between the second lens and the third lens on the optical axis has the shortest inter-lens distance among the first to sixth lenses, and a distance between the fifth lens and the sixth lens on the optical axis has the longest inter-lens distance among the first to sixth lenses.

15. The optical system of claim 14, wherein the fifth lens has the largest center thickness among the first to sixth lenses.

16. The optical system of claim 1, wherein the first lens, the second lens, and the third lens have positive composite power, and the fourth lens, the fifth lens, and the sixth lens have positive composite power.

17. A camera device comprising:
an image sensor;
a filter disposed on the image sensor; and
an optical system disposed on the filter,
wherein the optical system includes a first lens, a second lens, a third lens, a fourth lens, a fifth lens, and a sixth lens which are sequentially disposed from an object side to an image side,
the first lens has positive refractive power, the second lens has negative refractive power, the third lens has positive refractive power, the fourth lens has negative refractive power, the fifth lens has positive refractive power, and the sixth lens has negative refractive power,
an object-side surface of the sixth lens is concave toward the object side and an image-side surface of the fifth lens is convex toward the image side,
an object-side surface of the fifth lens and an image-side surface of the sixth lens include critical points at which the tilt angle is 0, and
the object-side surface of the sixth lens has a maximum tilt angle in a range of 0.8 to 1.2 times a vertical distance from an optical axis to the critical point of the image-side surface of the sixth lens.

18. The camera device of claim 17, wherein an effective diameter of an object-side surface of the first lens is smaller than a length in a diagonal direction of the image sensor.

19. The camera device of claim 17, wherein the image-side surface of the fifth lens has a maximum tilt angle in a range of 0.8 to 1.2 times a vertical distance from the optical axis to the critical point of the object-side surface of the fifth lens.

20. The camera device of claim 19, wherein:
the maximum tilt angle of the image-side surface of the fifth lens is 20 degrees to 30 degrees in the range of 0.8 to 1.2 times the vertical distance from the optical axis to the critical point of the object-side surface of the fifth lens; and
the maximum tilt angle of the object-side surface of the sixth lens is 35 degrees to 45 degrees in the range of 0.8 to 1.2 times the vertical distance from the optical axis to the critical point of the image-side surface of the sixth lens.
